(19) United States
(12) Patent Application Publication
(10) Pub. No.: US 2005/0174510 A1
(43) Pub. Date: Aug. 11, 2005

(54) Liquid crystal display device

(76) Inventors: Takakazu Yano, Tokyo (JP); Kazutoshi Takahashi, Saitama (JP); Kosei Miyabe, Saitama (JP); Kanetaka Sekiguchi, Saitama (JP); Takahiko Watanabe, Kanagawa (JP); Toshiaki Ishiyama, Kanagawa (JP); Shinya Ikeda, Kanagawa (JP)

Correspondence Address: SUGHRUE MION, PLLC, 2100 PENNSYLVANIA AVENUE, N.W., SUITE 800, WASHINGTON, DC, 20037, US

(21) Appl. No.: 10/510,286

(22) PCT Filed: Apr. 11, 2003
(86) PCT No.: PCT/JP03/04610

(51) Int. Cl. G02F 1/1335

(52) U.S. Cl. 349/98

(57) ABSTRACT

A difference in potential between a common power supply voltage and a data signal voltage required for driving an active-type liquid crystal display device is used, thereby making it possible to display a pictogram without additionally input a new signal to an opposite side. Moreover, a gray scale of a data signal is adjusted, thereby reducing a direct-current component in pictogram driving. A pictogram electrode in a pictogram display area is driven by a part of extra output terminals of a data driver for driving a moving image display area. With this, in a liquid crystal display device using thin-film transistors (TFTs) with a common substrate being an electrode on its entire surface, a simple structure including a moving image area and a pictogram display area is provided.

### TECHNICAL FIELD

The present invention relates to a liquid crystal display device that has a moving image display area and a pictogram display area. More particularly, the present invention relates to a liquid crystal display device in which display electrodes of the moving image display area are driven by a thin-film transistor.

### BACKGROUND ART

In recent years, portable electronic devices using a liquid crystal display device, such as electronic organizers and cellular phones, are widely available. Furthermore, in contrast to former electronic devices capable of displaying only still images, electronic devices capable of displaying moving images have become widespread.

In such portable electronic devices, pictogram display is becoming requisite. The pictogram display is a display of the state of exhaustion of the battery, which serves as the driving source, the state of an alarm, and, particularly in cellular phones, the state of an antenna level. Also, to achieve cost reduction and space saving in the portable electronic devices, some of the recently-available portable electronic devices have a moving image display area and a pictogram display area in one liquid crystal display device. The moving image display area is for displaying a main image, such as moving images, and the pictogram display area is for displaying a still fixed image, such as a pictogram.

For example, as for simple matrix liquid crystal display devices, Japanese Patent Application Laid-Open Publication No. 61-177487 discloses that a part of output terminals of a data-side integrated circuit is connected to a pictogram electrode of a pictogram display area. Moreover, Japanese Patent Application Laid-Open Publication No. 2000-10530 discloses a technology in which a part of output terminals of a data-side integrated circuit is connected to a pictogram electrode of an pictogram display area and a counter electrode formed on an opposed substrate to switch the pictogram electrode on and off by a difference in potential between the pictogram electrode and the counter electrode. Furthermore, a TFT liquid crystal display device is disclosed in Japanese Patent Application Laid-Open Publication No. 2001-183998. In the invention disclosed in Japanese Patent Application Laid-Open Publication No. 2001-183998 and its improvement disclosed in Japanese Patent Application Laid-Open Publication No. 2001-184000, a display device is disclosed which includes, on the same substrate, an unfixed image display area with its display electrodes disposed in matrix and a fixed image display area formed of segment electrodes. The unfixed image display area is provided with a thin-film transistor (TFT), which is a switching element, and a display electrode connected to this TFT. The TFT is supplied with a gate signal via a gate signal line from a gate driver and a drain signal via a drain signal from a drain driver.

Also, it is disclosed that the segment electrodes on the fixed image display area are supplied with a driving signal from a segment driver connected to an input unit.

However, in the inventions disclosed in Japanese Patent Application Laid-Open Publication Nos. 2001-183998 and 2001-184000, the segment electrodes on the fixed image display area are driven by a driving signal from the segment driver. The segment driver is provided separately from the drain driver. Therefore, such requirement of setting a segment driver separately from the drain driver does not fully satisfy the needs of space saving and cost reduction of portable electronic terminals.

Moreover, in the inventions disclosed in Japanese Patent Application Laid-Open Publication Nos. 2001-183998 and 2001-184000, no mention is made of specific input and output signals to the data-side integrated circuit or a relation between a power supply potential of a common electrode and a potential of a data output signal. Also, no suggestion is given about a problem in direct-current driving caused by the relation between the power supply potential of the common electrode and the potential of the data output signal. Furthermore, no disclosure is made of a driving operation for mitigating the problem.

Therefore, an object of the present invention is to provide a liquid crystal display device using a TFT and including two display areas, an area for displaying an unfixed image and an area for displaying a still and fixed image, wherein both of the unfixed image and the still fixed image can be driven by a single, space-saving, low-cost driving driver.

### DISCLOSURE OF THE INVENTION

To achieve the objects, a liquid crystal display device according to an aspect of the present invention is capable of displaying a moving image display area for displaying moving images and a pictogram display area. The moving image display area is formed by arranging display electrodes in a matrix and the display electrode being driven by thin-film transistor elements, and the pictogram display area is formed by disposing a segment electrode in a shape of a predetermined pictogram. A common electrode is provided at a position opposed to both the moving image display area and the pictogram display area. A scan-side integrated circuit for driving scan lines is provided so as to be connected to the scan lines connected to the thin-film transistors arranged in a row direction in the moving image display area. A data-side integrated circuit for driving data lines is provided so as to be connected to the data lines connected to the thin-film transistors arranged in a column direction in the moving image display area, and the data-side integrated circuit is provided with a larger number of output terminals than the data lines. The segment electrode is connected to an extra output terminal of the data-side integrated circuit, and a difference between a potential of the common electrode and a potential of an output signal from the data-side integrated circuit is used to display the pictogram in the pictogram display area.

According to the above aspect of the invention, an output signal from the data-side integrated circuit to the segment electrodes can be generated so that an output potential is varied for each predetermined period. Also, in the case, the output potential varied for each predetermined period is made within a voltage range of the potential of the common electrode, thereby suppressing a direct-current component caused by a difference between the potential of the data output signal and the potential of the common electrode. Furthermore, the predetermined period can be a period of inverting the polarity of the common electrode. Still further, the output potential varied for each predetermined period can be controlled by an input signal defining a gray tone to the data-side integrated circuit.

To achieve the objects, a liquid crystal display device according to another aspect of the present invention is capable of displaying a moving image display area for displaying moving images and a pictogram display area. The moving image display area is formed by arranging display electrodes in a matrix and the display electrodes are driven by moving-image thin-film transistor elements. The pictogram display area is formed by disposing a pictogram electrode in a shape of a predetermined pictogram, and the pictogram electrode are driven by a pictogram thin-film transistor element. A common electrode is provided at a position opposed to the moving image display area and the pictogram display area. A scan-side integrated circuit for driving scan lines is provided so as to be connected to the scan lines connected to the moving-image thin-film transistors arranged in a row direction in the moving image display area. A data-side integrated circuit for driving data lines is provided so as to be connected to the data lines connected to the moving-image thin-film transistors arranged in a column direction in the moving image display area. Either one of a source terminal or a drain terminal of the pictogram thin-film transistor is connected to, among a plurality of output terminals of the data-side integrated circuit, an output terminal that is different from output terminals to which the data lines connected to the moving-image thin-film transistors are connected, and other terminal of the pictogram thin-film transistor is connected to the pictogram electrode, other terminal of the pictogram thin-film transistor is connected to an output terminal of the scan-side integrated circuit, and a difference between a potential of the common electrode and a potential of the drain terminal of the pictogram thin-film transistor is used to display the pictogram in the pictogram display area.

According to the above aspect of the invention, the pictogram display area may be provided with a plurality of the pictogram electrodes and a plurality of the pictogram thin-film transistors, and gate terminals of the pictogram thin-film transistors may be connected to a same output terminal of the scan-side integrated circuit or to different output terminals of the scan-side integrated circuit. Also, one pictogram electrode may have connected thereto a plurality of the pictogram thin-film transistors. In this case, gate terminals of a plurality of the pictogram thin-film transistors connected to a same pictogram electrode may be connected to different output terminals of the scan-side integrated circuit. Furthermore, a gate terminal of the pictogram thin-film transistor may be connected to, among a plurality of output terminals of the scan-side integrated circuit, an output terminal that is different from output terminals to which scan lines connected to the moving image thin-film transistor are connected. Still further, the pictogram display area may be provided with the plurality of the pictogram electrodes and the plurality of the pictogram thin-film transistors, and source terminals of the plurality of the pictogram thin-film transistors may be connected to a same output terminal of the scan-side integrated circuit, and other terminals of the plurality of pictogram thin-film transistors may be connected to different output terminals of the scan-side integrated circuit.

According to the present invention, a part of the output terminals of the data-side integrated circuit can be used for pictogram display, thereby achieving space saving and low cost in the liquid crystal display device. At this time, as in the first aspect of the invention, when each of the pictogram electrodes in the pictogram display area is formed by a segment electrode, if a pictogram potential waveform applied to the segment electrode and a common power supply waveform applied to the common electrode are different in phase, the pictogram is displayed. If they are identical to each other in phase, the pictogram is not displayed. However, since a power supply potential on the common electrode is driven by correcting TFT elements having asymmetric electrical characteristics, the power supply potential is within a voltage range at a low potential (low offset potential) with respect to an output voltage range of the data-side integrated circuit. Therefore, depending on the degree of the potential, it may be required to control an output potential of the data-side integrated circuit with a data gray-scale input signal to suppress the occurrence of a direct-current component. On the other hand, as in the second aspect of the invention, when each of the pictogram electrodes is formed by a thin-film transistor, a difference between the potential of the drain terminal of the thin-film transistor and the potential applied to the common electrode causes the pictogram to be displayed. In this case, since the pictogram electrode is also driven by the thin-film transistor, a control for suppressing the occurrence of a direct-current component as in the first aspect of the invention is not required.

### BRIEF DESCRIPTION OF THE DRAWINGS

FIGS. 1A and 1B are perspective views of a portable device that includes a liquid crystal device according to an embodiment of the present invention, where FIG. 1A is a perspective view of a case when a pictogram display area has no background color, and FIG. 1B is a perspective view of a case when the pictogram display area has a background color;

FIG. 2 is an explanatory diagram for explaining an internal circuitry configuration of a first embodiment according to the present invention shown in FIGS. 1A and 1B;

FIG. 3 is a timing chart showing a method of driving the pictogram display area according to a first example (first mode) in the liquid crystal display device according to the present invention;

FIG. 4 is a waveform diagram showing transitions of voltages applied to pictogram electrodes in the driving method of FIG. 3;

FIG. 5 is a timing chart showing a method of driving the pictogram display area according to a second example (second mode) in the liquid crystal display device according to the present invention;

FIG. 6 is a waveform diagram showing transitions of voltages applied to pictogram electrodes in the driving method of FIG. 5;

FIGS. 7A and 7B are electrode pattern diagrams for explaining an arrangement of electrodes in the pictogram display area in the liquid crystal display device in the embodiment shown in FIG. 1B, where FIG. 7A is a diagram showing the state in which a voltage is applied only to the pictogram electrodes, and FIG. 7B is a diagram showing the state in which a voltage is applied only to a background electrode;

FIG. 8 is a timing chart showing a method of driving the pictogram display area according to a third example (third mode) in the liquid crystal display device according to the present invention;

FIG. 9 is a waveform diagram showing voltages applied to the pictogram electrodes and the background electrode in the driving method of FIG. 5;

FIG. 10 is an explanatory diagram for explaining an internal circuitry configuration of a fourth example (fourth mode) in a second embodiment according to the present invention;

FIG. 11 is a timing chart showing a method of driving the pictogram display area in the liquid crystal display device according to the fourth example (fourth mode) shown in FIG. 10;

FIG. 12 is an explanatory diagram for explaining an internal circuitry configuration of a fifth example (fifth mode) in the second embodiment according to the present invention;

FIG. 13 is a timing chart showing a method of driving the pictogram display area in the liquid crystal display device according to the fifth example (fifth mode) shown in FIG. 12;

FIG. 14 is an explanatory diagram for explaining an internal circuitry configuration of a sixth example (sixth mode) in the second embodiment according to the present invention;

FIG. 15 is an explanatory diagram for explaining an internal circuitry configuration of a seventh example (seventh mode) in the second embodiment according to the present invention;

FIG. 16 is a timing chart showing a method of driving the pictogram display area in the liquid crystal display device according to the seventh embodiment (seventh mode) shown in FIG. 15;

FIG. 17 is a continuation of the timing chart shown in FIG. 16;

FIG. 18 is an explanatory diagram for explaining an internal circuitry configuration of an eighth example (eighth mode) in the second embodiment according to the present invention;

FIG. 19 is a timing chart showing a method of driving the pictogram display area in the liquid crystal display device according to the eighth example (eighth mode) shown in FIG. 18;

FIG. 20 is an explanatory diagram for explaining an internal circuitry configuration of a ninth example (ninth mode) in the second embodiment according to the present invention; and

FIG. 21 is a timing chart showing a method of driving the pictogram display area in the liquid crystal display device according to the ninth example (ninth mode) shown in FIG. 20.

### BEST MODE FOR CARRYING OUT THE INVENTION

Exemplary embodiments of a liquid crystal device according to the present invention will be described below with reference to accompanying drawings.

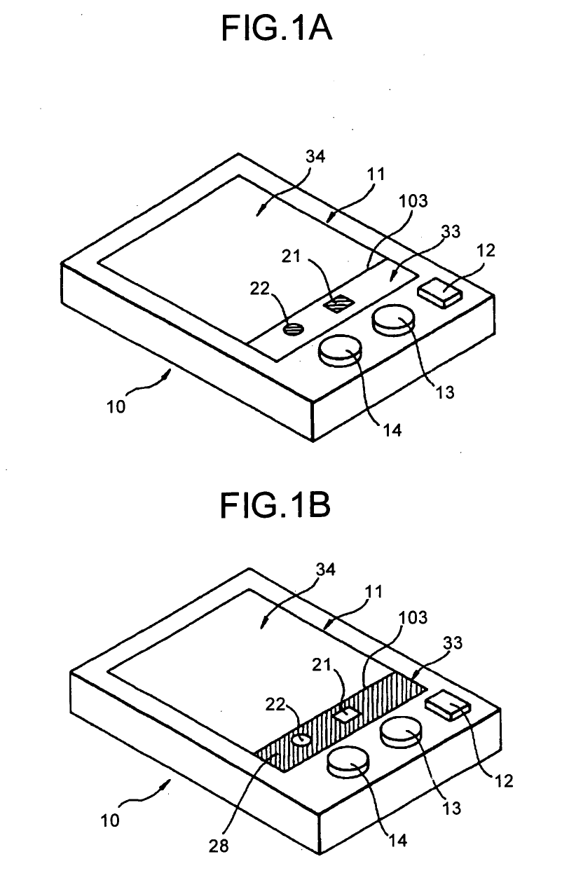

FIG. 1A is a perspective view of a portable device 10 that includes a liquid crystal device according to an embodiment of the present invention. The liquid crystal display device has a display screen 11. The portable device 10 includes a power supply switch 12, a first operating button 13, and a second operating button 14. Also, the display screen 11 is divided by a dividing line 103 into a pictogram display area 33 for displaying a fixed image, such as a pictogram, and a moving image display area 34 for displaying moving images. In the present example, the pictogram display area 33 includes rectangular a first pictogram 21 and a circular second pictogram 22. These pictograms 21 and 22 can be realized by providing segment electrodes to the pictogram display area 33. For example, the first pictogram 21 appears when the power supply is ON, while the second pictogram 22 appears when sound is OFF.

FIG. 1B is a perspective view of a modification of the portable device 10. The portable device 10 of the exemplary modification is different in structure from the portable device 10 shown FIG. 1A only in the display screen 11 of the liquid crystal display device, and other structures are exactly the same. Therefore, the same components are provided with the same reference numerals, and are not described herein. In the embodiment shown in FIG. 1A, the pictogram display area 33 on the display screen 11 does not have any background color. In the example shown in FIG. 1B, background electrodes surround the first pictogram 21 and the second pictogram 22 on this pictogram display area 33 to display a background 28 surrounding these pictograms.

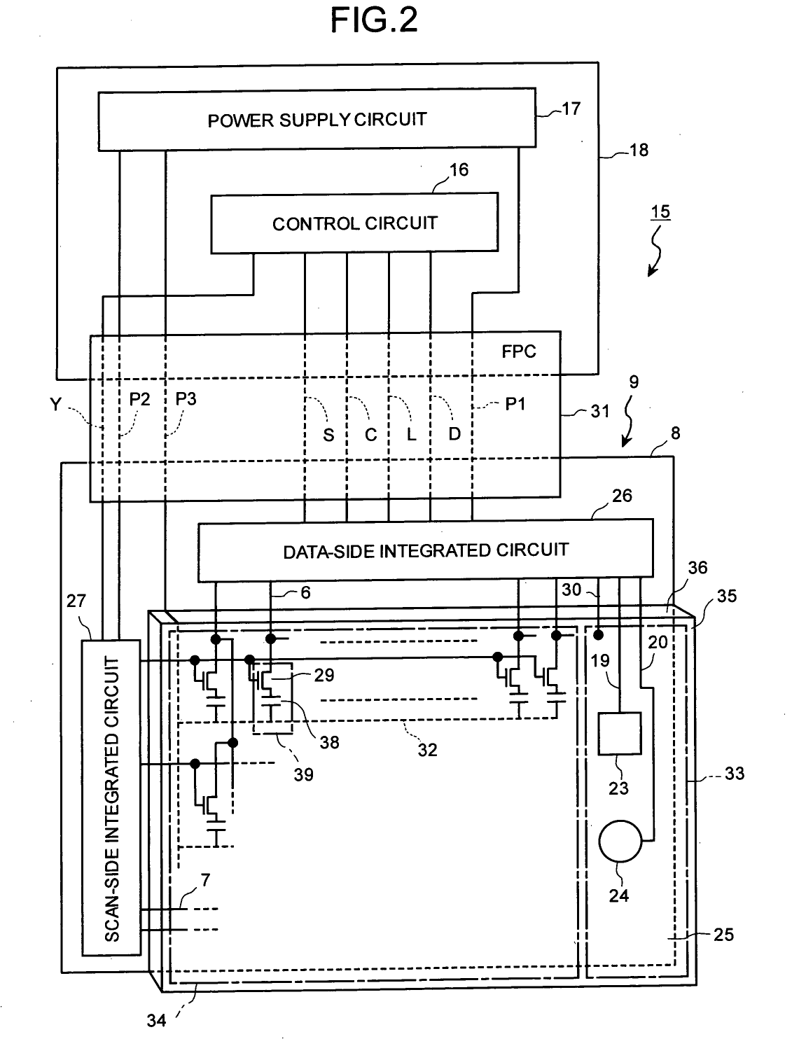

FIG. 2 is a diagram for explaining the structure of a liquid display device 15 incorporated in the portable device 10 according to the example of the present invention shown in FIGS. 1A and 1B. The liquid display device 15 includes a liquid crystal display unit 9, a print circuit board (PCB) having a control circuit 16, which is a signal generating circuit for liquid crystal display, and a power supply circuit 17 incorporated thereon, and a flexible print circuit board (FPC) 31 for supplying a signal and power from the PCB to the liquid crystal display unit 9.

The liquid crystal display unit 9 includes a data-side integrated circuit 26 and a scan-side integrated circuit 27 that are implemented through chip-on-glass (COG), an element substrate 8 having formed thereon display pixel electrodes and the like, a common substrate 35 provided at a position opposite to this element substrate 8, and a liquid crystal 36 injected between the element substrate 8 and the common substrate 35.

The display pixel electrodes formed on the element substrate 8 are each connected to a TFT (thin-film transistor). A common electrode 32 made of a transparent electrode film is formed on the entire surface of the common substrate 35. The display area of the liquid crystal display device 15 is divided into the pictogram display area 33 and the moving image display area 34. The pictogram display area 33 is for displaying a fixed still image, such as a pictogram that will be described further below, and the moving image display area 34 is for displaying moving images, an unfixed still image, or the like.

The resolution of the moving image display area 34 of the liquid crystal display device 15, that is, the number of display pixels provided on the element substrate 8, is 237 per row (horizontal direction) and 120 per column (vertical direction) in the present example. Also, the liquid crystal display device 15 according to the present example is a reflective liquid crystal display device in a light-reflecting (normally white) mode when no voltage is applied to the display pixel electrodes.

The FPC 31 and the PCB 18 are connected to each other by a crimp connector (not shown). The FPC 31 and the element substrate 8 are bonded through thermocompression by an anisotropic conductive sheet (ACS). Dotted lines shown on the FPC 31 represent wiring provided on the back side (back side of the page) of the FPC 31.

The FPC 31 has a function of supplying a signal generated by the control circuit 16, which is a signal generating circuit provided on the PCB 18, and power generated by the power supply circuit 17 to the data-side integrated circuit 26 and the scan-side integrated circuit 27, and inputting outputs from the data-side integrated circuit 26 and the scan-side integrated circuit 27 to TFTs 29 provided on the element substrate 8.

One of pixels 39 on the moving image display area 34 includes a TFT 29, a display pixel electrode 38 connected to the TFT 29, a common electrode 32 opposed to the display pixel electrode 38, a liquid crystal 36 sandwiched between the display pixel electrode 38 and the common electrode 32. Each pixel 39 is driven by an output of the data-side integrated circuit 26 as a data signal and an output of the scan-side integrated circuit 27 as a scanning signal. To achieve this, the data-side integrated circuit 26 is connected to 237 data lines 6 for moving images, while the scan-side integrated circuit 27 is connected to 120 scan lines 7 crossing the data lines 6. At an intersecting portion of each data line 6 and each scan line 7, one pixel 39 is formed. Therefore, the pixels 39 of 237 columns and 120 rows are driven through time-division line sequence driving (multiplex driving) to cause an image to be displayed on the display area 34. The data-side integrated circuit 26 is implemented through thermocompression by the anisotropic conductive sheet (ACS) to the element substrate 8.

On the other hand, in the present example, the pictogram display area 33 is provided with a first pictogram electrode 23, which is a segment electrode for displaying a first pictogram, and a second pictogram electrode 24, which is a segment electrode for displaying a second pictogram, both formed on the element substrate 8. Also, the first pictogram 23 and the second pictogram 24 may be surrounded by a background electrode 25 for displaying the background 28 described with reference to FIG. 1B. Thus, a signal line 19 to the first pictogram electrode 23, a signal line 20 to the second pictogram electrode 24, and, when the background 28 is formed, a signal line 30 to the background electrode 25 extend from the data-side integrated circuit 26. Therefore, in the present embodiment, the data-side integrated circuit 26 requires the moving image data lines 6 and fixed image signal lines 19, 20, and 30.

The signal lines 19 and 20 (and also the signal line 30 when the background electrode 25 is present) are lines other than the moving image data lines 6 provided to the data-side integrated circuit 26, and are connected to electrodes made of chromium (Cr) additionally provided to the data-side integrated circuit 26. The signal lines 19 and 20 (and the signal line 30 when the background electrode 25 is present) are connected to the first pictogram electrode 23 (rectangular pattern) and the second pictogram electrode 24 (and the background electrode 25 when the background is present) made of indium tin oxide (ITO).

The meaning of each wiring provided to the FPC 31 connecting the PCB 18 and the element substrate 8 together is described.

P1, P2, and P3 provided on the FPC 31 are power supply lines for supplying power from the power supply circuit 17 included in the PCB 18 to the element substrate 8. The first power supply line P1 includes a group of a plurality of power supply lines for supplying power at a ground (GND, a potential of 0 volt) and power at a potential of +5 volts to the data-side integrated circuit 26. Also, the second power supply line P2 includes a group of a plurality of power supply lines for supplying powers at, for example, a ground (0 volt), +5 volts, −15 volts, and +15 volts to the scan-side integrated circuit 27. The third power supply line P3 is a base signal line for, normally, supplying a common power defining a potential of the common electrode 32 on the common substrate 35 required for the operation of the TFTs 29 formed on the element substrate 8.

Also, D on the FPC 31 denotes a data signal line group, L denotes a latch signal line, C denotes a clock signal line, and S denotes a start signal line, each for transmission of a signal to the data-side integrated circuit 26. The data signal line group D is used to transfer a signal group defining a gray scale of the liquid display unit 9 to the data-side integrated circuit 26 and, in the present example, includes a data line of a 0-th bit, a data line of a first bit, a data line of a second bit, and a data line of a third bit. The latch signal line L is used to transfer a latch signal for defining a timing of outputting, from the data-side integrated circuit 26, data read into the data-side integrated circuit 26. The clock signal line C is used to transfer a signal defining a timing of reading a signal transferred through the data signal line group D. Also, the start signal line S is used to transfer a signal defining a timing of starting reading a data signal group transferred through the data signal line group D to the data-side integrated circuit 26.

Furthermore, Y on the FPC 31 denotes a synchronizing signal line group for transferring a synchronizing signal to the scan-side integrated circuit 27. This synchronizing signal line group Y includes a frame start signal and a row clock signal. This row clock signal is a signal defining a timing of selecting a row, while the frame start signal is a signal indicative of a timing of selecting a first row.

The scan-side integrated circuit 27 has a function of performing sequential scanning output in response to a signal supplied via the FPC 31. Also, the scan-side integrated circuit 27 sequentially selects one of scan lines 7 in the order such that a scan line 7 close to the data-side integrated circuit 26 is first selected, at a rising-timing of a clock signal upon an input of a frame start signal.

The operation of the liquid crystal display device 15 having the structure described above is described for three modes.

First Mode

As shown in FIG. 1A, the liquid crystal device 15 according to a first mode is not provided with a background electrode in the pictogram display area 33. The operation of the data-side integrated circuit 26 in this case is described.

When a signal of the start signal line S shown in FIG. 2 is supplied to the data-side integrated circuit 26, a data signal of the data signal line group D is read according to the rising timing of the signal of the clock signal line C. The data-side integrated circuit 26 outputs an output signal to the data line 6 and the signal lines 19 and 20 at the rising timing of the latch signal of the latch signal line L. This output signal is caused to have a potential corresponding to a 16 gray-scale display through a pulse height modulation (PHM) according to the data signal line group D. Similarly, the potential of the power to the common electrode 32 is changed at the rising timing of the latch signal.

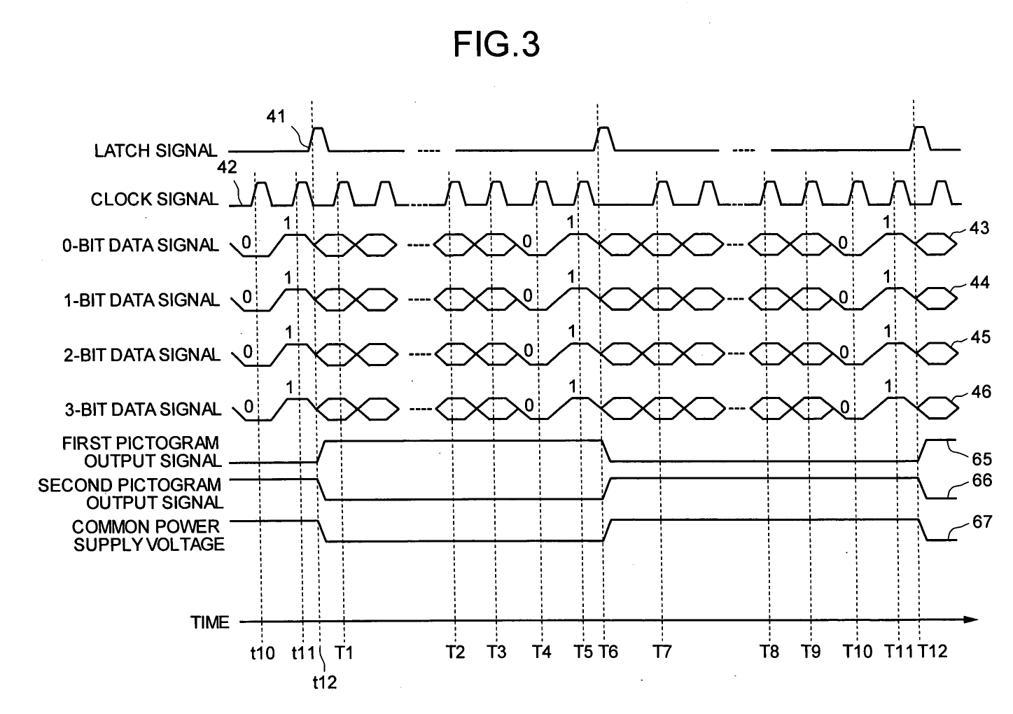

Next, a signal for driving the pictogram display area 33 is described in detail with reference to FIG. 3. FIG. 3 is a timing chart of input/output timings for explaining output signals from the data-side integrated circuit 26 to the first pictogram electrode 23 and the second pictogram electrode 24.

A latch signal 41 is a synchronizing signal for defining a timing of outputting, at its rising, an output signal of the data-side integrated circuit 26. A clock signal 42 is a synchronizing signal for defining a timing of inputting a data signal group to the data-side integrated circuit 26.

It is assumed that a signal flowing the data line of the 0-th bit of the data signal line group D is a 0-bit data signal 43, a signal flowing the data line of the first bit thereof is a 1-bit data signal 44, a signal flowing the data line of the second bit thereof is a 2-bit signal 45, and a signal flowing the data line of the third bit thereof is a 3-bit signal 46. The 0-bit data signal 43 is the lowest data signal to the data-side integrated circuit 26. The 1-bit data signal 44 is a second-bit data signal to the data-side integrated circuit 26. The 2-bit data signal 45 is a third-bit data signal to the data-side integrated circuit 26. The 3-bit data signal 46 is the highest data signal to the data-side integrated circuit 26.

The first pictogram output signal 65 is a signal output from the data-side integrated circuit 26 for driving the first pictogram electrode 23. The second pictogram output signal 66 is a signal output from the data-side integrated circuit 26 for driving the second pictogram electrode 24. Also, the common power supply voltage 67 indicates a potential of the common electrode 32 formed on the common substrate 35.

Next, the lighting operation of the first pictogram 21 and the second pictogram 22 is described with reference to the timing chart shown in FIG. 3. The moving image display area 34 includes 237 pixels per row, and it is assumed in the following description that the pixel at the left end is in a first column and the pixel at the right end is in a second column.

At a time T1, data of a first column is input to the data-side integrated circuit 26. Then, sequentially in synchronization with each rising of data signals, data of a second column onward is input to the data-side integrated circuit 26. At a time T2, data of a 237-th column is input to the data-side integrated circuit 26. That is, from the time T1 to the time T2, data of the moving image display area 34 is input to the data-side integrated circuit 26. At a time T3, data of a 238-th column is input to the data-side integrated circuit 26. At a time T4, data of a 239-th column is input to the data-side integrated circuit 26. At a time T5, data of a 240-th column is input to the data-side integrated circuit 26. That is, at the time T4, data regarding the lighting of the first pictogram 21 (an output signal output to the first pictogram electrode 23) is defined and, at the time T5, data regarding the lighting of the second pictogram 22 (an output signal output to the second pictogram electrode 24) is defined. Output signals reflecting the data read at the time T1, the time T2, the time T3, the time T4, and the time T5 are continuously output from a time T6 to a time T12.

As for the next row, at a time T7, data of the first column is input to the data-side integrated circuit 26. Thereafter, sequentially in synchronization with each rising of data signals, data of the second column onward is input to the data-side integrated circuit 26. At a time T8, data of the 237-th column is input to the data-side integrated circuit 26. That is, from the time T7 to the time T8, data of the moving image display area 34 is input to the data-side integrated circuit 26. At a time T9, data of the 238-th column is input to the data-side integrated circuit 26. At a time T10, data of the 239-th column is input to the data-side integrated circuit 26. At a time T11, data of the 240-th column is input to the data-side integrated circuit 26. That is, at the time T10, data regarding the lighting of the first pictogram 21 is defined. At the time T11, data regarding the lighting of the second pictogram 22 is defined.

Output signals reflecting the data read at the time T7, the time T8, the time T9, the time T10, and the time T11 are continuously output from the time T12.

Also, at a time t10 before the time T1, data of a 239-th column is input to the data-side integrated circuit 26. At a time t11, data of a 240-th column is input to the data-side integrated circuit 26. That is, at the time t10, data regarding the lighting of the first pictogram 21 is defined and, at the time t11, data regarding the lighting of the second pictogram 22 is defined.

Output signals reflecting the data read at the time t10 and the time t11 are continuously output from a time t12 to the time T6.

For alternate-current driving of the liquid crystal, the output reflects the data signal as it is when the common power supply voltage 67 is at a high level. When the common power supply voltage 67 is at a low level, the output reflects the input data signal as being inverted.

Therefore, the first pictogram output signal 65, which is an output from the data-side integrated circuit 26, reflects an inverted signal of “0000”, which is data at the time t10, for output at the high level at the time t12. Then, the output signal reflects “0000”, which is data at the time T4, as it is for output at the low level at the time T6. Then, the output signal reflects an inverted signal of “0000”, which is data at the time T10, for output at the high level at the time T12.

On the other hand, the second pictogram output signal 66, which is an output from the data-side integrated circuit 26, reflects an inverted signal of “1111”, which is data at the time t11, for output at the low level at the time t12. Then, the output signal reflects “11111”, which is data at the time T5, as it is for output at the high level at the time T6. Then, the output signal reflects an inverted signal of “1111”, which is data at the time T11, for output at the low level at the time T12.

Note herein that the low level is taken as “0”, while the high level is taken as “1”.

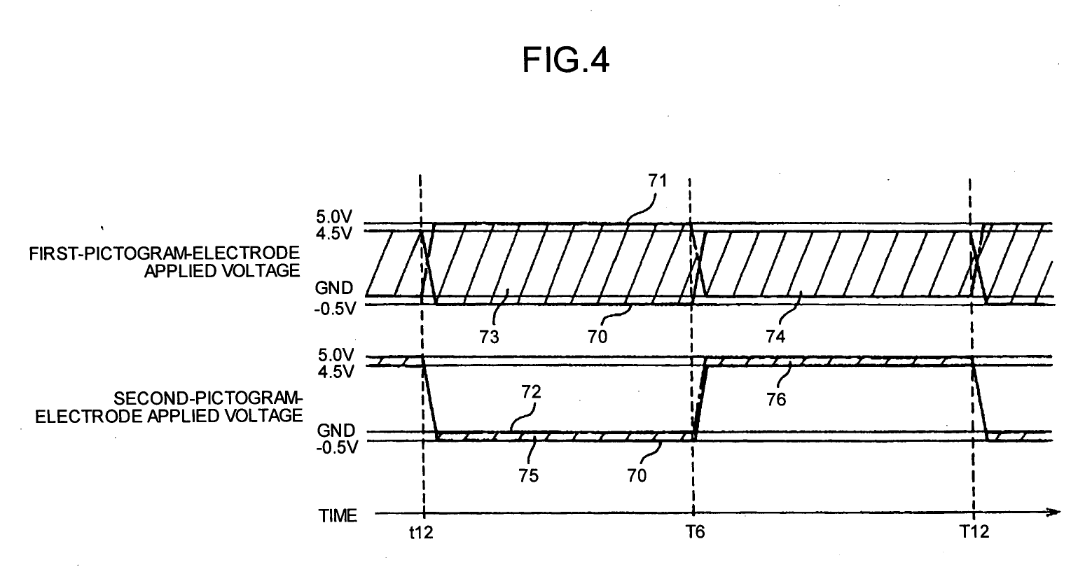

Next, since the liquid crystal is driven depending on effective values, the voltage applied to the pictogram electrode 23 and 24 and the effective values are described by using FIG. 4. A first-pictogram-electrode applied voltage represents a voltage actually applied to the first pictogram electrode 23 and its effective values.

A common-power-supply potential waveform 70 shown by a solid line represents an alternate-current power in which its potential is varied between −0.5 volt as a bottom and +4.5 volts because of the characteristics of TFT driving. At the time t12, the potential is changed from +4.5 volts to −0.5 volt. At the time T6, the potential is changed from −0.5 volt to +4.5 volts. At the time T12, the potential is changed from +4.5 volts to −0.5 volt.

A first-pictogram potential waveform 71 shown by a one-dot-chain line is an alternate-current power in which a potential of the common voltage is varied between GND (0 volt) as a bottom and +5.0 volts. At the time t12, the potential is changed from GND to +5.0 volts. At the time T6, the potential is changed from +5.0 volts to GND. At the time T12, the potential is changed from GND to +5.0 volts.

A first effective value 73 is an effective value occurring due to a difference in potential between +5.0 volts of the first-pictogram potential waveform 71 and −0.5 volt of the common-power-supply potential waveform 70. A second effective value 74 is an effective value occurring due to a difference in potential between GND of the first-pictogram potential waveform 71 and +4.5 volts of the common-power-supply potential waveform 70. With an average effective value of 5 volts root-mean-square (rms) obtained from the first effective value 73 (5.5 volts rms) and the second effective value 74 (4.5 volts rms), the first pictogram 21 in the normally-white liquid crystal display device is displayed in black.

A second-pictogram-electrode applied voltage represents a voltage actually applied to the second pictogram electrode 24 and its effective values. In a second-pictogram potential waveform 72 shown by a one-dot-chain line, the potential is varied between GND (0 volt) as a bottom and +5.0 volts. At the time t12, the potential is changed from +5.0 volts to GND. At the time T6, the potential is changed from GND to +5.0 volts. At the time T12, the potential is changed from +5.0 volts to GND.

A third effective value 75 is an effective value occurring due to a difference in potential between GND of the second-pictogram potential waveform 72 and −0.5 volt of the common-power-supply potential waveform 70. A fourth effective value 76 is an effective value occurring due to a difference in potential between +5.0 volts of the second-pictogram potential waveform 72 and +4.5 volts of the common-power-supply potential waveform 70. An average effective value obtained from the third effective value 75 (0.5 volt rms) and the fourth effective value 76 (0.5 volt rms) is 0.5 volt rms. Since a normal optical change of the liquid crystal is started with 1.5 volts rms to 2.0 volts rms, the second pictogram 22 in the normally-white liquid crystal display device is displayed in white.

When the common-power-supply potential waveform 70 is taken as a reference, a difference in potential of the first-pictogram potential waveform 71 having the first effective value 73 is +5.5 volts, while a difference in potential of the first-pictogram potential waveform 71 having the second effective value 74 is −4.5 volt. Therefore, 0.5 volt is generated as an average direct-current component. Also, when the common-power-supply potential waveform 70 is taken as a reference, a difference in potential from the second-pictogram potential waveform 72 in the third effective value 75 is +0.5 volt, while a difference in potential from the second-pictogram potential waveform 72 in the fourth effective value 76 is +0.5 volt. Therefore, 0.5 volt is generated as an average direct-current component. This direct-current component may cause a problem of deterioration or stain depending on the liquid crystal material. However, if an appropriate liquid crystal material is selected and the common power supply is adjusted, such a problem can be mitigated.

In the first embodiment, description has been made with the common electrode voltage of −0.5 volt to +4.5 volts. This potential is not restrictive. Furthermore, this is not meant to define the potential from GND to +5.0 volts of the output voltage.

Second Mode

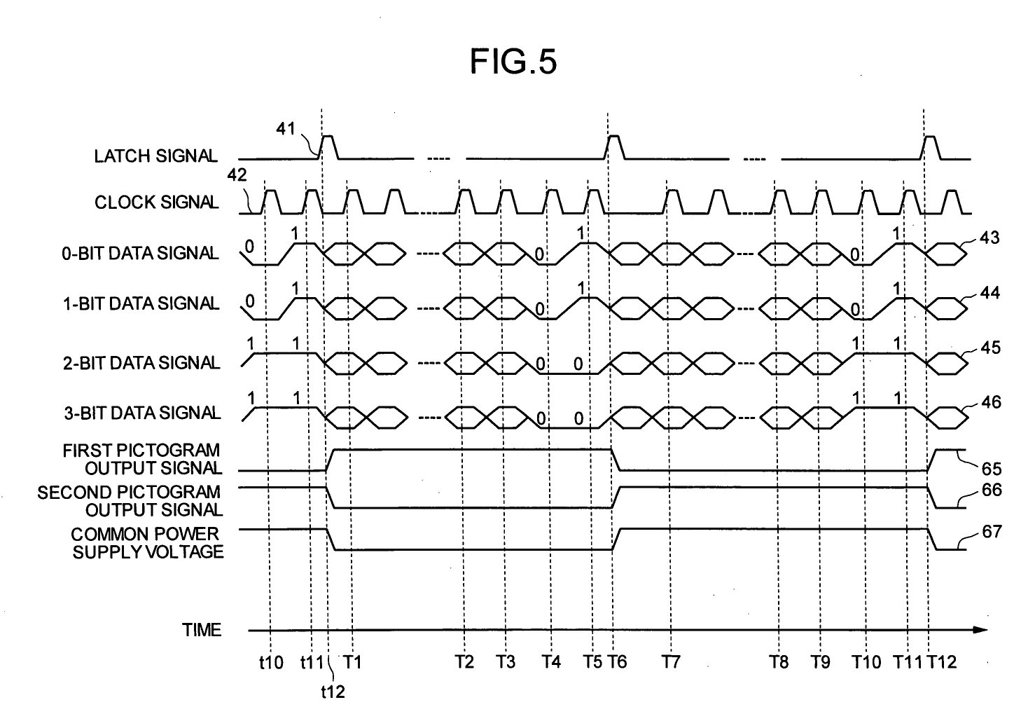

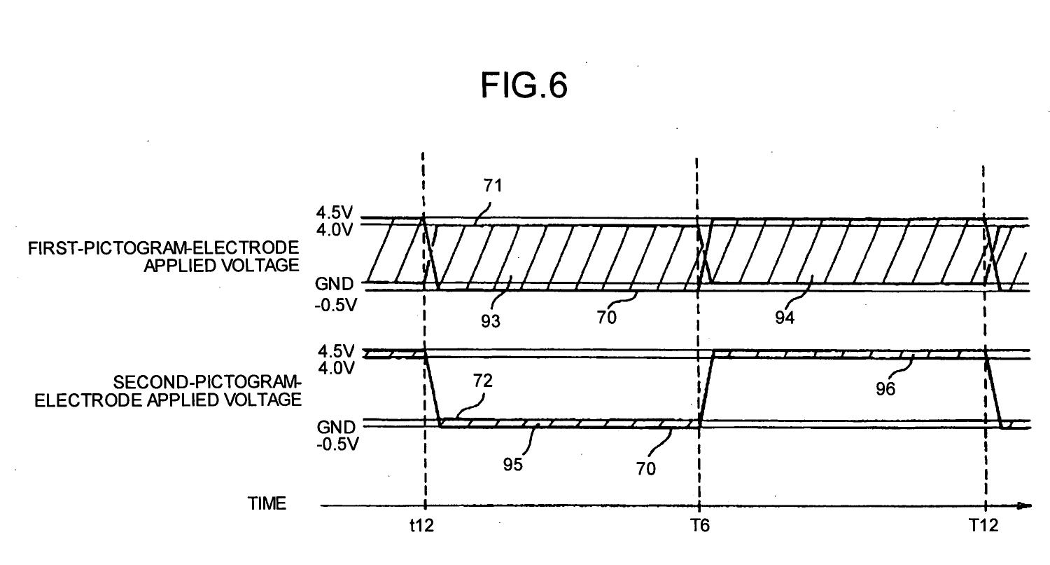

Next, a second mode is described with reference to FIGS. 5 and 6, in which the direct-current component described in the first mode is reduced by adjusting a gray tone. First, the operation of the liquid crystal display device 15 according to the second mode is described according to a timing chart shown in FIG. 5. The liquid crystal display device 15 according to the second mode is also not provided with a background electrode in the pictogram display area 33.

FIG. 5 is a timing chart showing input/output timings for explaining pictogram lighting of the data-side integrated circuit 26. The latch signal 41 is a synchronizing signal for defining a timing of outputting, at its rising, an output signal of the data-side integrated circuit 26. The clock signal 42 is a synchronizing signal for defining a timing of inputting a data signal group to the data-side integrated circuit 26.

The 0-bit data signal 43 is the lowest data signal to the data-side integrated circuit 26. The 1-bit data signal 44 is a data signal of the second bit to the data-side integrated circuit 26. The 2-bit data signal 45 is a data signal of the third bit to the data-side integrated circuit 26. The 3-bit data signal 46 is the highest data signal to the data-side integrated circuit 26.

The first pictogram output signal 65 is a signal output from the data-side integrated circuit 26 for driving the first pictogram electrode 23. The second pictogram output signal 66 is a signal output from the data-side integrated circuit 26 for driving the second pictogram electrode 24. Also, the common power supply voltage 67 indicates a potential of the common electrode 32 formed on the common substrate 35.

At the time T1, data of the first column is input to the data-side integrated circuit 26. Then, sequentially in synchronization with each rising of data signals, data of the second column onward is input to the data-side integrated circuit 26. At the time T2, data of the 237-th column is input to the data-side integrated circuit 26. That is, from the time T1 to the time T2, data of the moving image display area 34 is input to the data-side integrated circuit 26. At the time T3, data of the 238-th column is input to the data-side integrated circuit 26. At the time T4, data of the 239-th column is input to the data-side integrated circuit 26. At the time T5, data of the 240-th column is input to the data-side integrated circuit 26. That is, at the time T4, data regarding the lighting of the first pictogram 21 is defined and, at the time T5, data regarding the lighting of the second pictogram 22 is defined. Output signals reflecting the data read at the time T1, the time T2, the time T3, the time T4, and the time T5 are continuously output from the time T6 to the time T12.

As for the next row, at the time T7, data of the first column is input to the data-side integrated circuit 26. Then, sequentially in synchronization with each rising of data signals, data of the second column onward is input to the data-side integrated circuit 26. At the time T8, data of the 237-th column is input to the data-side integrated circuit 26. That is, from the time T7 to the time T8, data of the moving image display area 34 is input to the data-side integrated circuit 26. At the time T9, data of the 238-th column is input to the data-side integrated circuit 26. At the time T10, data of the 239-th column is input to the data-side integrated circuit 26. At the time T11, data of the 240-th column is input to the data-side integrated circuit 26. That is, at the time T10, data regarding the lighting of the first pictogram 21 is defined and, at the time T11, data regarding the lighting of the second pictogram 22 is defined.

Output signals reflecting the data read at the time T7, the time T8, the time T9, the time T10, and the time T11 are continuously output from the time T12.

Also, at the time t10 before the time T1, data of the 239-th column is input to the data-side integrated circuit 26. At the time t11, data of the 240-th column is input to the data-side integrated circuit 26. That is, at the time t10, data regarding the lighting of the first pictogram 21 is defined and, at the time t11, data regarding the lighting of the second pictogram 22 is defined.

Output signals reflecting the data read at the time t10 and the time t11 are continuously output from a time t12 to the time T6.

For alternate-current driving of the liquid crystal, the output reflects the data signal as it is when the common power supply voltage 67 is at a high level. When the common power supply voltage 67 is at a low level, the output reflects the input data signal as being inverted.

Therefore, the first pictogram output signal 65, which is an output from the data-side integrated circuit 26, reflects an inverted signal of “0011”, which is data at the time t10, for output at a level close to the high level (5.0 volts×12/15=4.0 volts) at the time t12. Then, the output signal reflects “0000”, which is data at the time T4, as it is for output at the low level at the time T6. Then, the output signal reflects an inverted signal of “0011”, which is data at the time T10, for output at a level close to the high level (5.0 volts×12/15=4.0 volts) at the time T12.

On the other hand, the second pictogram output signal 66, which is an output from the data-side integrated circuit 26, reflects an inverted signal of “1111”, which is data at the time t11, for output at the low level at the time t12. Then, the output signal reflects “1100”, which is data at the time T5, as it is for output at a level close to the high level (5.0 volts×12/15=4.0 volts) at the time T6. Then, the output signal reflects an inverted signal of “1111”, which is data at the time T11, for output at the low level at the time T12.

Next, since the liquid crystal is driven depending on effective values, the voltage applied to the pictogram electrode 23 and 24 and the effective values are described by using FIG. 6. The first-pictogram-electrode applied voltage represents a voltage actually applied to the first pictogram electrode 23 and its effective values. The common-power-supply potential waveform 70 shown by a solid line is an alternate-current power in which a potential of the common voltage is varied between −0.5 volt as a bottom and +4.5 volts because of the characteristics of TFT driving. At the time t12, the potential is changed from +4.5 volts to −0.5 volt. At the time T6, the potential is changed from −0.5 volt to +4.5 volts. At the time T12, the potential is changed from +4.5 volts to −0.5 volt.

The first-pictogram potential waveform 71 shown by a one-dot-chain line represents an alternate-current power in which its potential is varied between GND (0 volt) as a bottom and +4.0 volts. At the time t12, the first-pictogram potential waveform 71 becomes at a potential (5.0 volts×12/15=4.0 volts) corresponding to the inverted signal of “0011”, which is data read at the time t10 shown in FIG. 5. That is, at the time t12, the potential is changed from GND to +4.0 volts. Also, at the time T6, the potential is changed correspondingly to “0000”, which is data read at the time T4 shown in FIG. 5. That is, at the time T6, the potential is changed from +4.0 volts to GND. At the time T12, the first-pictogram potential waveform 71 becomes at a potential corresponding to the inverted signal of “0011”, which is data read at the time T10 shown in FIG. 5. That is, at the time T12, the potential is changed from GND to +4.0 volts.

A fifth effective value 93 is an effective value occurring due to a difference in potential between +4.0 volts of the first-pictogram potential waveform 71 and −0.5 volt of the potential of the common-power-supply potential waveform 70. A sixth effective value 94 is an effective value occurring due to a difference in potential between GND of the first-pictogram potential waveform 71 and +4.5 volts of the common-power-supply potential waveform 70. With an average effective value of 4.5 volts rms obtained from the fifth effective value 93 (4.5 volts rms) and the sixth effective value 94 (4.5 volts rms), the first pictogram 21 in the normally-white liquid crystal display device is displayed in black.

The second-pictogram-electrode applied voltage represents a voltage actually applied to the second pictogram electrode 24 and its effective values. In the second-pictogram potential waveform 72 shown by a one-dot-chain line, the potential is varied between GND (0 volt) as a bottom and +4.0 volts. At the time t12, the second-pictogram potential waveform 72 becomes at a potential corresponding to the inverted signal of “1111”, which is data read at the time t11 shown in FIG. 5. That is, the potential is changed from +4.0 volts to GND. At the time T6, the potential is changed correspondingly to “1100”, which is data read at the time T5 shown in FIG. 5. That is, at the time T6, the potential is changed from GND to +4.0 volts. At the time T12, the second pictogram potential waveform 72 becomes at a potential corresponding to an inverted signal of “1111”, which is data read at the time T11 shown in FIG. 5. That is, at the time T12, the potential is changed from +4.0 volts to GND.

A seventh effective value 95 is an effective value occurring due to a difference in potential between GND of the second-pictogram potential waveform 72 and −0.5 volt of the common-power-supply potential waveform 70. An eighth effective value 96 is an effective value occurring due to a difference in potential between +4.0 volts of the second-pictogram potential waveform 72 and +4.5 volts of the common-power-supply potential waveform 70. An average effective value obtained from the seventh effective value 95 (0.5 volt rms) and the eighth effective value 96 (0.5 volt rms) is 0.5 volt rms. Since a normal optical main change of the liquid crystal is started with 1.5 volts rms to 2.0 volts rms, the second pictogram 22 in the normally-white liquid crystal display device is displayed in white.

When the common-power-supply potential waveform 70 is taken as a reference, a difference in potential from the first-pictogram potential waveform 71 in the fifth effective value 93 is +4.5 volts, while a difference in potential from the first-pictogram potential waveform 71 in the sixth effective value 94 is −4.5 volt. No average direct-current component is generated. Also, when the common-power-supply potential waveform 70 is taken as a reference, a difference in potential from the second-pictogram potential waveform 72 in the seventh effective value 95 is +0.5 volt, while a difference in potential from the second-pictogram potential waveform 72 in the eighth effective value 96 is −0.5 volt. Therefore, no average direct-current component is generated. That is, this allows a problem of deterioration, stain, or the like to be less prone to occur. In practice, gray tone adjustment is performed by adjusting discrete potentials, it is difficult to completely prevent such a current component from occurring. However, such an occurrence can be significantly reduced.

In the second mode, gray tone adjustment is performed on a high potential side. As a matter of course, adjustment can be performed on a low potential side. Also, adjustment can be performed for on both of high and low potential sides.

Third Mode

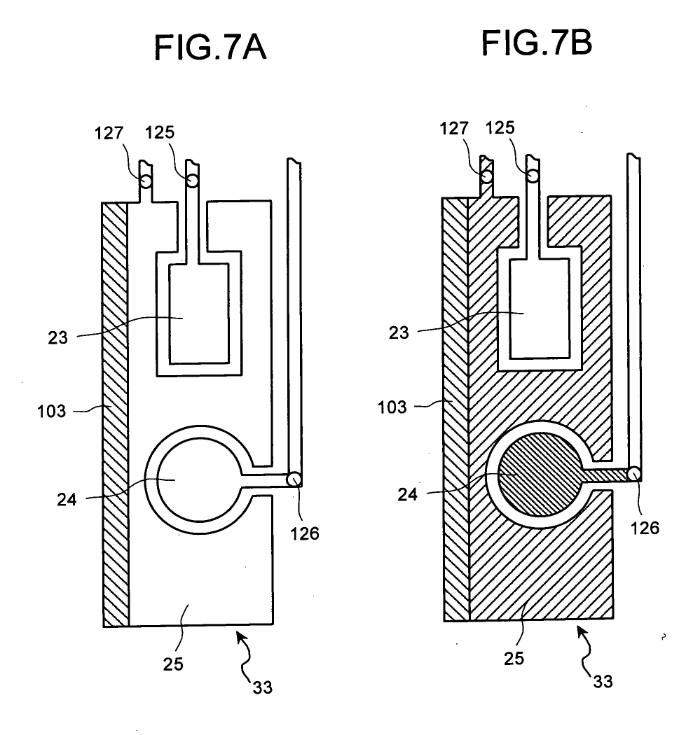

Next, description is made to the case of driving a liquid crystal device 15 capable of displaying the background 28 shown in FIG. 1B in the manner that is same as that explained in the second mode. FIG. 7A illustrates patterns when power is off, while FIG. 7B illustrates patterns when power is on.

In the third mode, the first pictogram electrode 23 is in a rectangular pattern formed of indium tin oxide (ITO). The first pictogram electrode 23 is connected via a contact hole 125 to a 239-th output terminal of the data-side integrated circuit 26. The second pictogram electrode 24 is in a circular pattern formed of ITO. The second pictogram electrode 24 is connected via a contact hole 126 to a 240-th output terminal of the data-side integrated circuit 26. The background electrode 25 is disposed so as to surround and be spaced apart from the first pictogram electrode 23 and the second pictogram electrode 24, and is connected via a contact hole 127 to a 238-th output terminal of the data-side integrated circuit 26. As shown in FIGS. 1A and 1B the dividing line 103 is to distinguish between the moving image display area 34 and the pictogram display area 33, and is formed of chromium (Cr) for use as wiring at the time of forming a TFT element.

Since the liquid crystal display device 15 is in normally-white mode, in the state shown in FIG. 7A where power is off, only the dividing line 103 is displayed in black (denoted by diagonal lines), while the other pictogram display areas are white. On the other hand, in the state shown in FIG. 7B where power is on, the first pictogram electrode 23 is displayed in white, while the second pictogram electrode 24 and the background electrode 25 are displayed in black (denoted by diagonal lines). The dividing line 103 is left displayed in black. As such, with the background electrode 25 being provided to the pictogram display area 33, a boundary between the moving image display area 34 and the pictogram display area 33 is made clear, thereby making it easy to view the moving images.

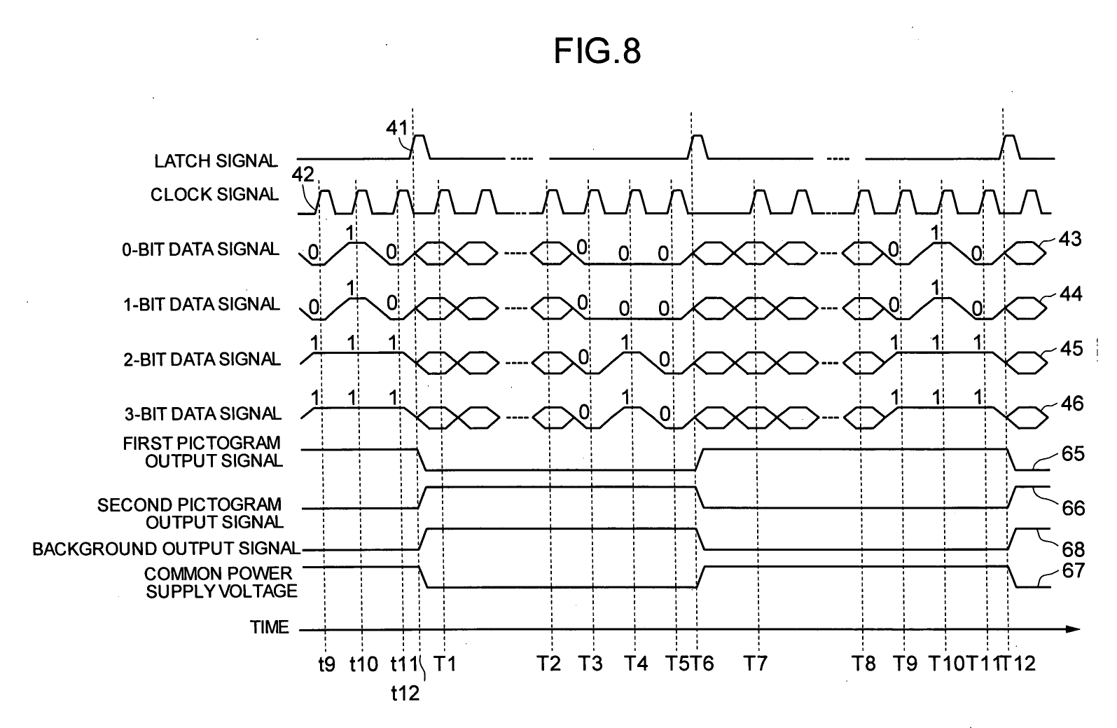

The operation in the state shown in FIG. 7B is described according to a timing chart diagram shown in FIG. 8. FIG. 8 is a timing chart showing input/output timings for explaining pictogram lighting of the data-side integrated circuit 26. The latch signal 41 is a synchronizing signal for defining a timing of outputting, at its rising, an output signal of the data-side integrated circuit 26. The clock signal 42 is a synchronizing signal for defining a timing of inputting a data signal group to the data-side integrated circuit 26.

The 0-bit data signal 43 is the lowest data signal to the data-side integrated circuit 26. The 1-bit data signal 44 is a data signal of the second bit to the data-side integrated circuit 26. The 2-bit data signal 45 is a data signal of the third bit to the data-side integrated circuit 26. The 3-bit data signal 46 is the highest data signal to the data-side integrated circuit 26.

The first pictogram output signal 65 is a signal output from the data-side integrated circuit 26 for driving the first pictogram electrode 23. The second pictogram output signal 66 is a signal output from the data-side integrated circuit 26 for driving the second pictogram electrode 24. Also, a background output signal 68 is a signal output from the data-side integrated circuit 26 for driving the background electrode 25.

At the time T1, data of the first column is input to the data-side integrated circuit 26. Then, sequentially in synchronization with each rising of data signals, data of the second column onward is input to the data-side integrated circuit 26. At the time T2, data of the 237-th column is input to the data-side integrated circuit 26. That is, from the time T1 to the time T2, moving image data is input to the data-side integrated circuit 26. At the time T3, data of the 238-th column is input to the data-side integrated circuit 26. At the time T4, data of the 239-th column is input to the data-side integrated circuit 26. At the time T5, data of the 240-th column is input to the data-side integrated circuit 26. That is, data regarding the lighting of the background electrode 25 is defined at the time T3, data regarding the lighting of the first pictogram electrode 21 is defined at the time T4, and data regarding the lighting of the second pictogram electrode 22 is defined at the time T5. Output signals reflecting the data read at the time T1, the time T2, the time T3, the time T4, and the time T5 are continuously output from the time T6 to the time T12.

As for the next row, at the time T7, data of the first column is input to the data-side integrated circuit 26. Thereafter, sequentially in synchronization with each rising of data signals, data of the second column onward is input to the data-side integrated circuit 26. At the time T8, data of the 237-th column is input to the data-side integrated circuit 26. That is, from the time T7 to the time T8, data of the moving image display area 34 is input to the data-side integrated circuit 26. At the time T9, data of the 238-th column is input to the data-side integrated circuit 26. At the time T10, data of the 239-th column is input to the data-side integrated circuit 26. At the time T11, data of the 240-th column is input to the data-side integrated circuit 26. That is, data regarding the lighting of the background electrode 25 is defined at the time T9, data regarding the lighting of the first pictogram electrode 21 is defined at the time T10, and data regarding the lighting of the second pictogram electrode 22 is defined at the time T11.

Output signals reflecting the data read at the time T7, the time T8, the time T9, the time T10, and the time T11 are continuously output from the time T12.

Also, at a time t9 before the time T1, data of the 238-th column is input to the data-side integrated circuit 26. At the time t10, data of the 239-th column is input to the data-side integrated circuit 26. At the time t11, data of the 240-th column is input to the data-side integrated circuit 26. That is, data regarding the lighting of the background electrode 25 is defined at the time t9, data regarding the lighting of the first pictogram electrode 21 is defined at the time t10, and data regarding the lighting of the second pictogram electrode 22 is defined at the time t11.

Output signals reflecting the data read at the time t9, the time t10, and the time t11 are continuously output from a time t12 to the time T6.

For alternate-current driving of the liquid crystal, the output reflects the data signal as it is when the common power supply voltage 67 is at a high level. When the common power supply voltage 67 is at a low level, the output reflects the input data signal as being inverted.

Therefore, the first pictogram output signal 65, which is an output from the data-side integrated circuit 26, reflects an inverted signal of “1111”, which is data at the time t10, for output at the low level at the time t12. Then, the output signal reflects “0011”, which is data at the time T4, as it is for output at a level close to the high level at the time T6. Then, the output signal reflects an inverted signal of “1111”, which is data at the time T10, for output at the low level at the time T12.

The second pictogram output signal 66, which is an output from the data-side integrated circuit 26, reflects an inverted signal of “0011”, which is data at the time t11, for output at a level close to the high level at the time t12. Then, the output signal reflects “0000”, which is data at the time T5, for output at the low level at the time T6. Then, the output signal reflects an inverted signal of “0011”, which is data at the time T11, for output at a level close to the high level at the time T12.

The background electrode output signal 68, which is an output from the data-side integrated circuit 26, reflects an inverted signal of “0011”, which is data at the time t9 for output at a level close to the high level at the time t12. Then, the output signal reflects “0000”, which is data at the time T3, for output at the low level at the time T6. Then, the output signal reflects an inverted signal “0011”, which is data at the time T9, for output at a level close to the high level at the time T12.

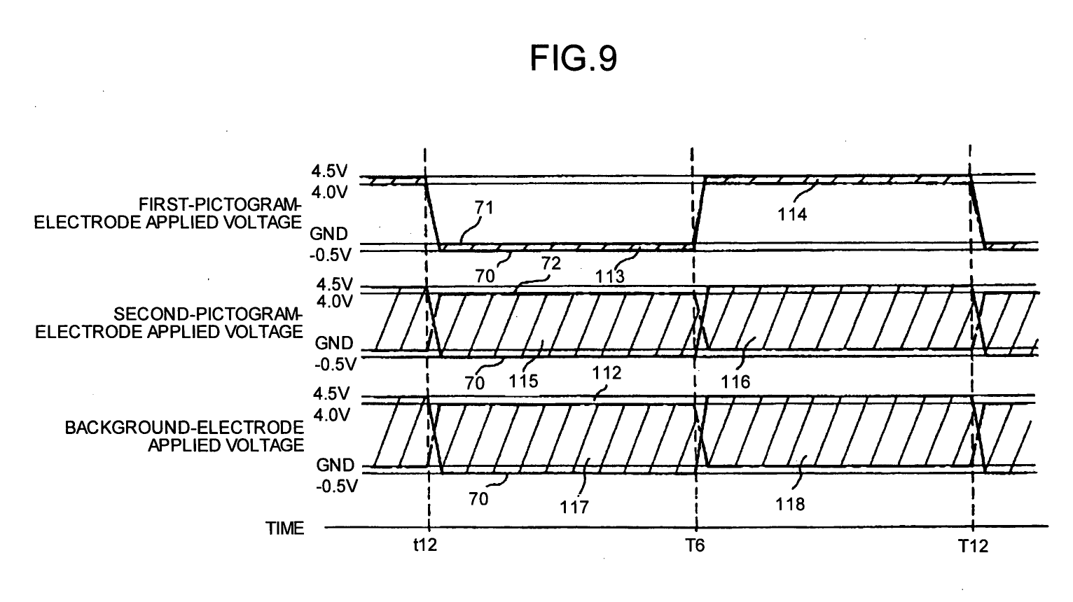

Next, since the liquid crystal is driven depending on effective values, the voltage applied to the pictogram display areas and the effective values are described by using FIG. 9. The first-pictogram-electrode applied voltage represents a voltage actually applied to the first pictogram electrode 23 and its effective values. The common-power-supply potential waveform 70 shown by a solid line represents an alternate-current power in which the potential of the common voltage is varied between −0.5 volt as a bottom and +4.5 volts because of the characteristics of TFT driving. At the time t12, the potential is changed from +4.5 volts to −0.5 volt. At the time T6, the potential is changed from −0.5 volt to +4.5 volts. At the time T12, the potential is changed from +4.5 volts to −0.5 volt.

The first-pictogram potential waveform 71 shown by a one-dot-chain line is an alternate-current power in which the potential of the common voltage is varied between GND (0 volt) as a bottom and +4.0 volts. At the time t12, the first-pictogram potential waveform 71 becomes at a potential (0 volt) corresponding to the inverted signal of “1111”, which is data read at the time t10 shown in FIG. 8. That is, at the time t12, the potential is changed to GND. Also, at the time T6, the electrode becomes at a potential (5.0 volts×12/15=4.0 volts) corresponding to “0011”, which is data read at the time T4 shown in FIG. 8. That is, at the time T6, the potential is changed from GND to +4.0 volts. At the time T12, the first-pictogram potential waveform 71 becomes at a potential corresponding to the inverted signal of “1111”, which is data read at the time T10 shown in FIG. 8. That is, at the time T12, the potential is changed from +4.0 volts to GND.

A ninth effective value 113 is an effective value occurring due to a difference in potential between GND of the first-pictogram potential waveform 71 and −0.5 volts of the potential having the common-power-supply potential waveform 70. A tenth effective value 114 is an effective value occurring due to a difference in potential between +4.0 volts of the first-pictogram potential waveform 71 and +4.5 volts of the common-power-supply potential waveform 70. An average effective value obtained from the ninth effective value 113 (0.5 volt rms) and the tenth effective value 114 (0.5 volt rms) is 0.5 volt rms. Since a normal optical change of the liquid crystal is started with 1.5 volts rms to 2.0 volts rms, the first pictogram 21 in the normally-white liquid crystal display device is displayed in white.

The second-pictogram-electrode applied voltage represents a voltage actually applied to the second pictogram electrode 24 and its effective values. The common-power-supply potential waveform 70 shown by a solid line represents an alternate-current power in which a potential of the common voltage is varied between −0.5 volt as a bottom and +4.5 volts because of the characteristics of TFT driving. At the time t12, the potential is changed from +4.5 volts to −0.5 volt. At the time T6, the potential is changed from −0.5 volt to +4.5 volts. At the time T12, the potential is changed from +4.5 volts to −0.5 volt.

The second-pictogram potential waveform 72 shown by a one-dot-chain line is an alternate signal in which the potential is varied between GND (0 volt) as a bottom and +4.0 volts. At the time t12, the second-pictogram potential waveform 72 becomes at a potential (5.0 volts×12/15=4.0 volts) corresponding to the inverted signal of “0011”, which is data read at the time t12 shown in FIG. 8. That is, at the time t12, the potential is changed to +4.0 volts. Also, at the time T6, the potential is changed correspondingly to “0000”, which is data read at the time T5 shown in FIG. 8. That is, at the time T6, the potential is changed from +4.0 volts to GND. At the time T12, the second pictogram potential waveform 72 becomes at a potential (5.0 volts×12/15=4.0 volts) corresponding to an inverted signal of “0011”, which is data read at the time T11 shown in FIG. 8. That is, at the time T12, the potential is changed from GND to +4.0 volts.

An eleventh effective value 115 is an effective value occurring due to a difference in potential between +4.0 volts of the second-pictogram potential waveform 71 and −0.5 volt of the common-power-supply potential waveform 70. A twelfth effective value 116 is an effective value occurring due to a difference in potential between GND of the second-pictogram potential waveform 72 and +4.5 volts of the common-power-supply potential waveform 70. An average effective value obtained from the eleventh effective value 115 (4.5 volts rms) and the twelfth effective value 116 (4.5 volts rms) is 4.5 volts rms. Since a normal optical change of the liquid crystal is started with 1.5 volts rms to 2.0 volts rms, the second pictogram 22 in the normally-white liquid crystal display device is displayed in black.

The background-electrode applied voltage represents a voltage actually applied to the background electrode 25 and its effective values. The common-power-supply potential waveform 70 shown by a solid line is an alternate-current power in which a potential of the common voltage is varied between −0.5 volt as a bottom and +4.5 volts because of the characteristics of TFT driving. At the time t12, the potential is changed from +4.5 volts to −0.5 volt. At the time T6, the potential is changed from −0.5 volt to +4.5 volts. At the time T12, the potential is changed from +4.5 volts to −0.5 volt.

The background-electrode potential waveform 112 shown by a one-dot-chain line represents an alternate signal whose potential is varied between GND (0 volt) as a bottom and +4.0 volts. At the time t12, the electrode having the background-electrode potential waveform 112 becomes at a potential (5.0 volts×12/15=4.0 volts) corresponding to the inverted signal of “0011”, which is data read at the time t9 shown in FIG. 8. That is, at the time t12, the potential is changed to +4.0 volts. Also, at the time T6, the potential is changed correspondingly to “0000”, which is data read at the time T3 shown in FIG. 8. That is, at the time T6, the potential is changed from +4.0 volts to GND. At the time T12, the background-electrode potential waveform 112 becomes at a potential (5.0 volts×12/15=4.0 volts) corresponding to “0011”, which is data read at the time T9 shown in FIG. 8. That is, at the time T12, the potential is changed from GND to +4.0 volts.

A thirteenth effective value 117 is an effective value occurring due to a difference in potential between +4.0 volts of the background-electrode potential waveform 112 and −0.5 volt of the common-power-supply potential waveform 70. A fourteenth effective value 118 is an effective value occurring due to a difference in potential between GND of the background-electrode potential waveform 112 and +4.5 volts of the common-power-supply potential waveform 70. An average effective value obtained from the thirteenth effective value 117 (4.5 volts rms) and the fourteenth effective value 118 (4.5 volts rms) is 4.5 volts rms. Since a normal optical change of the liquid crystal is started with 1.5 volts rms to 2.0 volts rms, the background electrode 25 in the normally-white liquid crystal display device is displayed in black.

The background electrode 25 is black, the first pictogram electrode 23 is white, and the second pictogram electrode 23 is black. Therefore, in the pictogram display area 33, only the first pictogram 21 is viewed as being lit in white.

Description has been made so far to the structure, as the first embodiment, in which, in the pictogram display area 33, the first pictogram electrode 23 and the data-side integrated circuit 26 are directly connected to each other by the signal line 19, and the second pictogram electrode 24 and the data-side integrated circuit 26 are directly connected to each other by another signal line 20. Next, as a second embodiment, six modes are provided to describe a structure in which, as with the moving image display area 34, in the pictogram display area 33, TFTs (thin-film transistors) are connected to the first pictogram electrode 23 and the second pictogram electrode 24, and a pictogram is displayed with a difference in potential between the drain terminal of each of the TFTs and the common electrode 32. The same effects can be obtained even when the source terminal and the drain terminal are interchanged in position with each other.

Fourth Mode

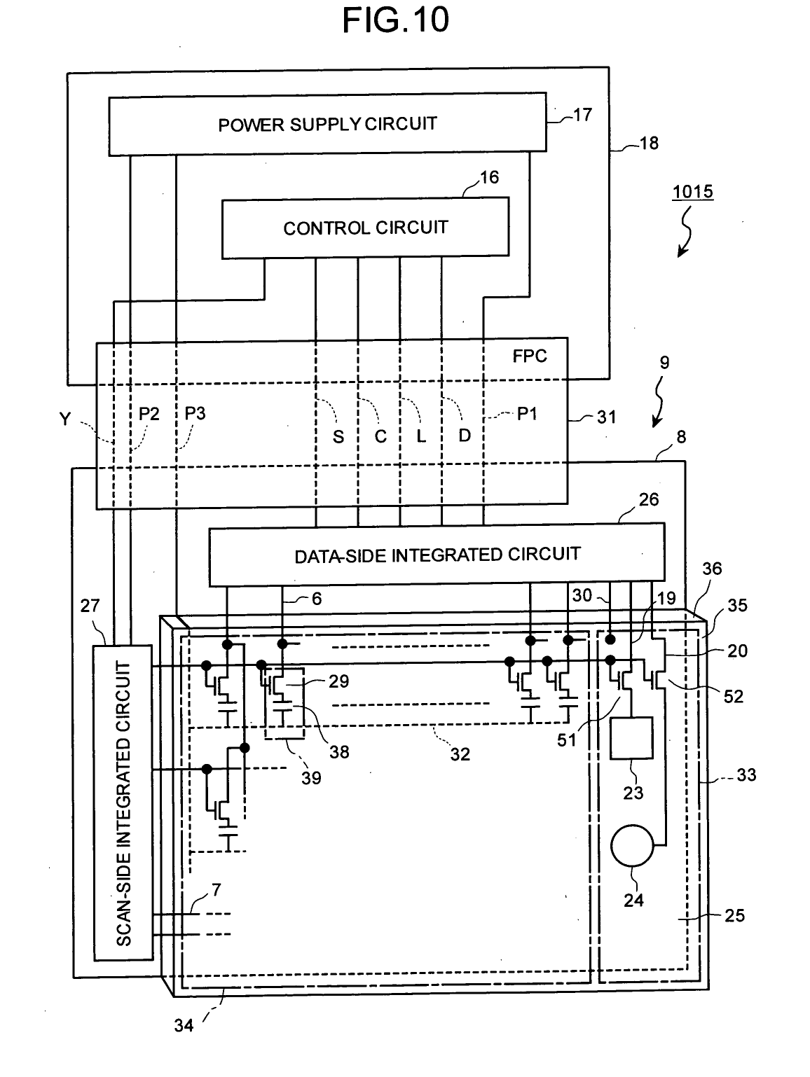

FIG. 10 is a diagram for explaining the structure of a liquid crystal display device 1015 according to the second embodiment incorporated in the portable device 10 according to the example of the present invention shown in FIGS. 1A and 1B. The liquid crystal display device 1015 according to a fourth mode has a structure in which, in the pictogram display area 33, the first pictogram electrode 23 for displaying a first pictogram is driven by a first pictogram thin-film transistor (TFT) 51, while the second pictogram electrode 24 for displaying a second pictogram is driven by a second pictogram thin-film transistor (TFT) 52. Other than that, the structure of the liquid crystal display device 1015 is identical to that of the liquid crystal display device 15 (refer to FIG. 2) according to the first to third modes. Therefore, components identical to those of the liquid crystal display device 15 shown in FIG. 2 are provided with the same reference numerals, and are not described herein for avoiding redundancy.

The first pictogram TFT 51 is provided on the element board 8. Any one of the source terminal and the drain terminal of the first pictogram TFT 51 is connected to the signal line 19. This signal line 19 is a line other than the moving image data line 6 provided to the data-side integrated circuit 26, and is connected to an electrode made of chromium (Cr) metal additionally provided to the data-side integrated circuit 26. The other terminal of the first pictogram TFT 51 is connected to the first pictogram electrode 23. The gate terminal of the first pictogram TFT 51 is connected to any one, not particularly restricted, of 120 scan lines 7 connected to the scan-side integrated circuit 27, for example, in the example shown in FIG. 10, a scan line 7 on the first row, together with the gate terminals of the 237 TFTs 29 arranged on the first row of the moving image display area 34.

The second pictogram TFT 52 is provided on the element board 8. Any one of the source terminal and the drain terminal of the second pictogram TFT 52 is connected to the signal line 20. This signal line 20 is a line other than the moving image data line 6 provided to the data-side integrated circuit 26, and is connected to an electrode made of chromium (Cr) metal additionally provided to the data-side integrated circuit 26. In the fourth mode, the first pictogram TFT 51 and the second pictogram TFT 52 are connected to different electrodes in the data-side integrated circuit 26. The other terminal of the second pictogram TFT 52 is connected to the second pictogram electrode 24. The gate terminal of the second pictogram TFT 52 is connected to the same scan line 7 to which the gate terminal of the first pictogram TFT 51 is connected, that is, in the example shown in FIG. 10, the scan line 7 on the first row.

Therefore, the FPC 31 performs a function of inputting outputs from the data-side integrated circuit 26 and the scan-side integrated circuit 27 not only to the TFTs 29 in the moving image display area 34, but also to the first pictogram TFT 51 and the second pictogram TFT 52 in the pictogram display area 33. Pixels of the first pictogram 21 include the first pictogram TFT 51, the first pictogram electrode 23 connected to the first pictogram TFT 51, the common electrode 32 opposed to the first pictogram electrode 23, and the liquid crystal 36 sandwiched between the first pictogram electrode 23 and the common electrode 32. Also, the pixels of the second pictogram 22 include the connected to the second pictogram TFT 52, the common electrode 32 opposed to the second pictogram electrode 24, and the liquid crystal 36 sandwiched between the second pictogram electrode 24 and the common electrode 32. The pixels of these pictograms are driven by an output of the data-side integrated circuit 26 as a data signal and an output of the scan-side integrated circuit 27 as a scanning signal.

When the pictogram display area 33 is provided with the background electrode 25 for displaying the background 28 (refer to FIG. 1B), the background electrode 25 may be connected to the signal line 30, and this signal line 30 may be connected to the electrode made of chromium (Cr) metal additionally provided to the data-side integrated circuit 26. Alternatively, as with the first pictogram electrode 23, the background electrode 25 may be connected via a TFT to an electrode made of chromium (Cr) metal additionally provided to the data-side integrated circuit 26. In this case, the source terminal of the TFT is connected via the signal line 30 to the data-side integrated circuit 26, with its drain terminal being connected to the background electrode 25 and its gate terminal being connected to the same scan line 7 to which the gate terminal of the first pictogram TFT 51 is connected, or another scan line 7.

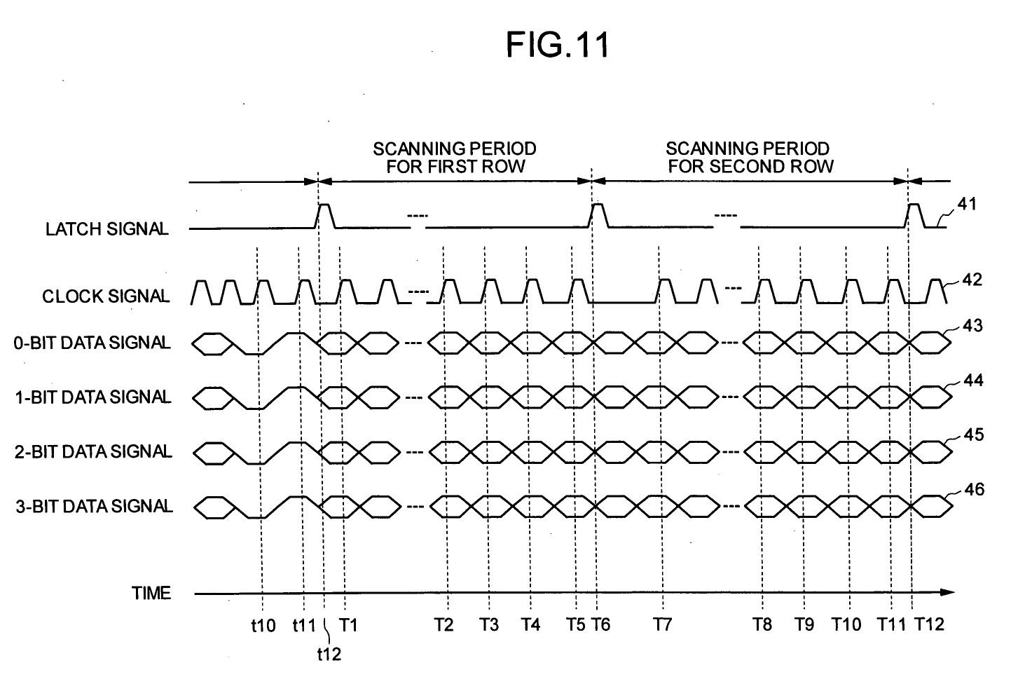

Next, the operation of the liquid crystal display device 1015 having the structure described above is described according to a timing chart shown in FIG. 11. The liquid crystal display device 1015 according to the fourth mode is not provided with a background electrode in the pictogram display area 33. FIG. 11 is a timing chart showing input/output timings for explaining pictogram lighting of the data-side integrated circuit 26.

The latch signal 41 is a synchronizing signal for defining a timing of outputting, at its rising, an output signal of the data-side integrated circuit 26. The clock signal 42 is a synchronizing signal for defining a timing of inputting a data signal group to the data-side integrated circuit 26. The 0-bit data signal 43 is the lowest data signal to the data-side integrated circuit 26. The 1-bit data signal 44 is a data signal of the second bit to the data-side integrated circuit 26. The 2-bit data signal 45 is a data signal of the third bit to the data-side integrated circuit 26. The 3-bit data signal 46 is the highest data signal to the data-side integrated circuit 26. The first pictogram output signal 65, the second pictogram output signal 66, and the common power supply voltage 67 are not shown.

As shown in FIG. 11, data for displaying the first row is input to the data-side integrated circuit 26 immediately before a scanning period for the first row. At the time t10 during the period in which the data for displaying the first row is input, data of a 239-th column is input to the data-side integrated circuit 26. At the time t11, data of a 240-th column is input to the data-side integrated circuit 26. That is, at the time t10, data regarding the lighting of the first pictogram 21 is defined and, at the time t11, data regarding the lighting of the second pictogram 22 is defined. In the example shown in FIG. 11, the data of the 239-th column input at the time t10 is “0000”, while the data of the 240-th column input at the time t11 is “11111”, although this is not meant to be particularly restrictive.

The output signal reflecting the data for displaying the first row read by the time t11 is continuously output during a scanning period for the first row from the time t12 to the time T6. During the period from the time t12 to the time T6, the 237 TFTs in the moving image display area 34, the first pictogram TFT 51, and the second pictogram TFT 52 connected to the scan line 7 on the first row are in the ON state. Therefore, the output signal reflecting the data read at the time t10 and the time t11 is supplied to the first pictogram electrode 23 and the second pictogram electrode 24, thereby controlling the lighting of the first pictogram 21 and the second pictogram 22.

During the period from the time t12 to the time T6, the output signal reflecting the data for displaying the first row is output from the data-side integrated circuit 26. At the same time, data for displaying the second row is input to the data-side integrated circuit 26. At the time T1, data of the first column on the second row is input to the data-side integrated circuit 26. Then, sequentially in synchronization with each rising of data signals, data of the second column onward on the second row is input to the data-side integrated circuit 26. At the time T2, data of the 237-th column on the second row is input to the data-side integrated circuit 26. That is, from the time T1 to the time T2, data for displaying the second row of the moving image display area 34 is input to the data-side integrated circuit 26. At the time T3, the time T4, and the time T5, data of the 238-th column, the 239-th column, and the 240-th column, respectively, are input to the data-side integrated circuit 26.

Output signals reflecting the data for displaying the second row read from the time T1 to the time T2, the time T3, the time T4, and the T5 are continuously output during the scanning period for the second row from the time T6 to the time T12. However, during the period from the time T6 to the time 12, the 237 TFTs in the moving image display area 34 connected to the scan line 7 on the second row are in the ON state, while the first pictogram TFT 51 and the second pictogram TFT 52 are in the OFF state. Therefore, the first pictogram electrode 23 and the second pictogram electrode 24 are not supplied with data for display. That is, the data of the 239-th column and the data of the 240-th column read at the time T4 and the time T5, respectively, do not contribute to a display control of the first pictogram 21 and the second pictogram 22. The same goes for the data for displaying the third row onward. Therefore, with the data of the 239-th column and the data of 240-th column read together with the data for displaying the first row being excluded, data of the 239-th column and data of the 240-th column read together with the data for displaying the second row onward, that is, data of the 239-th column and data of the 240-th column read during a scanning period after the scanning period for the first row, may be taken as being undefined.

During the period from the time T6 to the time T12, an output signal reflecting the data for displaying the second row is output from the data-side integrated circuit 26. At the same time, the data for displaying the third row is input to the data-side integrated circuit 26. At the time T7, data of the first column on the third row is input to the data-side integrated circuit 26. Then, sequentially in synchronization with each rising of data signals, data of the second column onward on the third row is input to the data-side integrated circuit 26. At the time T8, data of the 237-th column on the third row is input to the data-side integrated circuit 26. That is, from the time T7 to the time T8, data for displaying the third row of the moving image display area 34 is input to the data-side integrated circuit 26. At the time T9, the time T10, and the time T11, data of the 238-th column, the 239-th column, and the 240-th column, respectively, (such data may be undefined) are input to the data-side integrated circuit 26. The same goes for the fourth row onward.

For alternate-current driving of the liquid crystal, when the common power supply voltage 67 is at a high level, the output becomes as reflecting the data signal. When the common power supply voltage 67 is at a low level, the output becomes the input data signal being inverted.

Fifth Mode

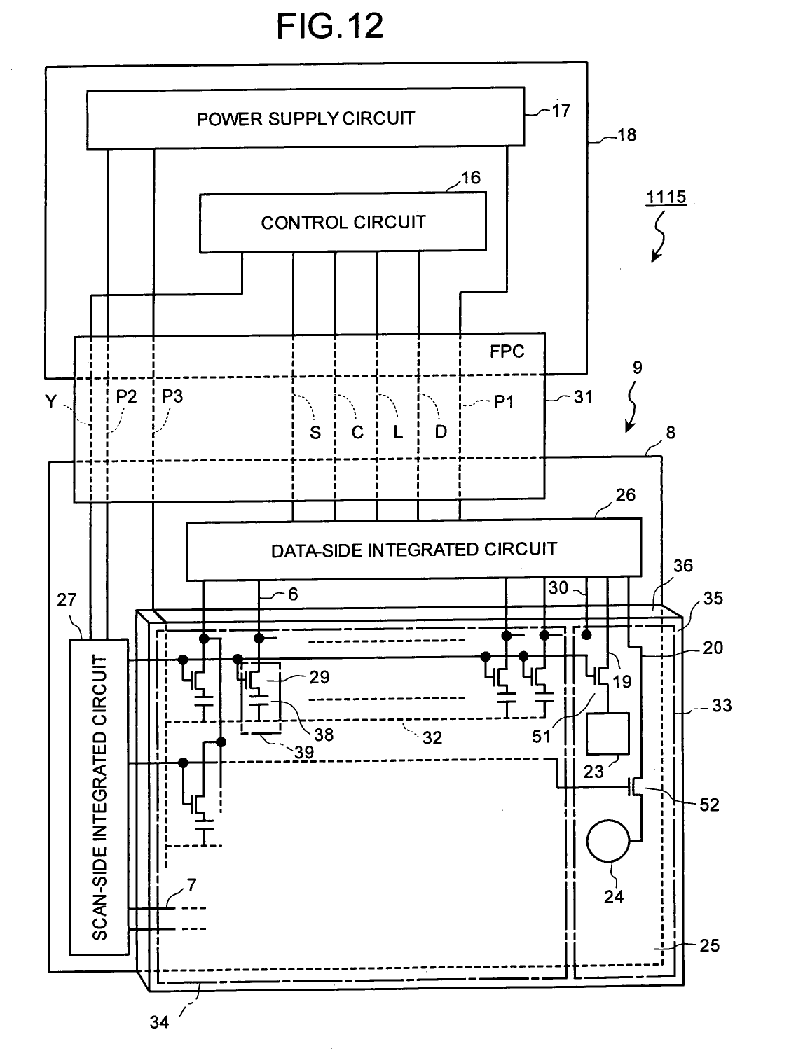

FIG. 12 is a diagram for explaining the structure of a liquid crystal display device 1115 according to the second embodiment incorporated in the portable device 10 according to the example of the present invention shown in FIGS. 1A and 1B. The liquid crystal display device 1115 according to a fifth mode has a structure in which, in the pictogram display area 33, the first pictogram electrode 23 for displaying a first pictogram is driven by the first pictogram TFT 51, while the second pictogram electrode 24 for displaying a second pictogram is driven by the second pictogram TFT 52, wherein the first pictogram TFT 51 and the second pictogram TFT 52 are caused to be in the ON state at different timings. That is, in the structure of the fourth mode described above, the gate terminal of the first pictogram TFT 51 and the gate terminal of the second pictogram TFT 52 are connected to different electrodes in the scan-side integrated circuit 27. Other than that, the structure of the liquid crystal display device 1115 is identical to that of the liquid crystal display device 15 (refer to FIG. 2) according to the first to third modes. Therefore, components identical to those of the liquid crystal display device 15 shown in FIG. 2 are provided with the same reference numerals, and are not described herein for avoiding redundancy.

Hereinafter, only the difference in structure from the fourth mode is described. The gate terminal of the first pictogram TFT 51 is connected to any one, not particularly restricted, of 120 scan lines 7 connected to the scan-side integrated circuit 27, for example, a scan line 7 on the first row shown in FIG. 12, together with the gate terminals of the 237 TFTs 29 arranged on the first row in the moving image display area 34. The gate terminal of the second pictogram TFT 52 is connected to a scan line 7 that is different from the scan line to which the gate terminal of the first pictogram TFT 51 is connected, for example, a scan line 7 on an L-th (in the present embodiment, L is an integer from 2 to 120) line, together with the gate terminals of the 237 TFTs 29 arranged on the L-th row in the moving image display area 34.

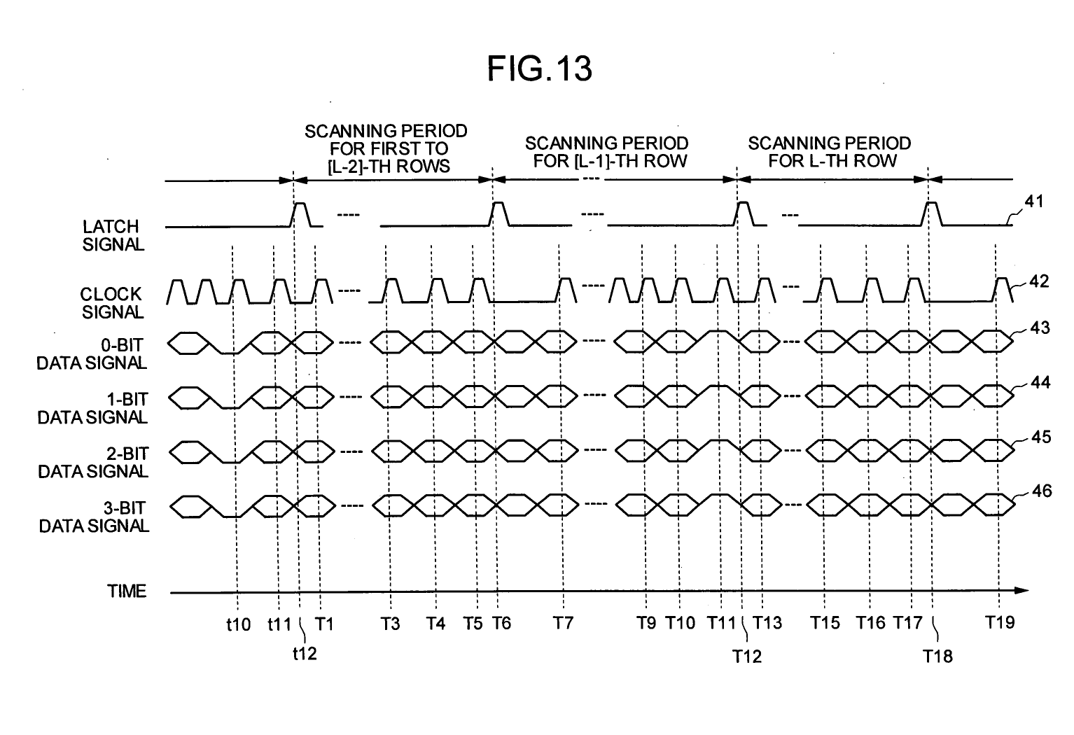

Next, the operation of the liquid crystal display device 1115 having the structure described above is described according to a timing chart shown in FIG. 13. The liquid crystal display device 1115 according to the fifth mode is not provided with a background electrode in the pictogram display area 33. FIG. 13 is a timing chart showing input/output timings for explaining pictogram lighting of the data-side integrated circuit 26.

As shown in FIG. 13, data for displaying the first row is input to the data-side integrated circuit 26 immediately before a scanning period for the first row. At the time t10 in the period in which the data for displaying the first row is input, data of the 239-th column is input to the data-side integrated circuit 26. At the time t11, data of the 240-th column is input to the data-side integrated circuit 26. That is, at the time t10, data regarding the lighting of the first pictogram 21 is defined. In the example shown in FIG. 13, the data of the 239-th column input at the time t10 is “0000”, although this is not meant to be particularly restrictive.

Output signals reflecting the data for displaying the first row read by the time t11 are continuously output during the scanning period for the first row from the time t12 to the time T6. During the period from the time t12 to the time T6, the 237 TFTs in the moving image display area 34 and the first pictogram TFT connected to the scan line 7 on the first row 51 are in the ON state. Therefore, an output signal reflecting the data read at the time t10 is supplied to the first pictogram electrode 23, thereby controlling the lighting of the first pictogram 21. On the other hand, during the period from the time t12 to the time T6, the second pictogram TFT 52 is in the OFF state. Therefore, the second pictogram electrode 24 is not supplied with data for display. That is, the data of the 240-th column read at the time t11 does not contribute to a display control of the second pictogram 22. Therefore, the data of 240-th column read together with the data for displaying the first row may be taken as being undefined.

During the period from the time t12 to the time T6, an output signal reflecting the data for displaying the first row is output from the data-side integrated circuit 26. At the same time, the data for displaying the second row is input to the data-side integrated circuit 26. At the time T1, data of the first column on the second row is input to the data-side integrated circuit 26. Then, sequentially in synchronization with each rising of data signals, data of the second column onward on the second row is input to the data-side integrated circuit 26. At the time T2 (omitted in FIG. 13), data of the 237-th column on the second row is input to the data-side integrated circuit 26. That is, from the time T1 to the time T2, the data for displaying the second row of the moving image display area 34 is input to the data-side integrated circuit 26. At the time T3, the time T4, and the time T5, data of the 238-th column, 239-th column, and the 240-th column, respectively, are input to the data-side integrated circuit 26.

Output signals reflecting the data for displaying the second row read from the time T1 to the time T2, the time T3, the time 4, and the time T5 are continuously output during the scanning period for the second row from the time t12 to the time T6 (in FIG. 13, collectively represented by a scanning period for the first to [L−2]-th rows). However, during the scanning period for the second row from the time t12 to the time T6, the 237 TFTs in the moving image display area 34 connected to the scan line 7 on the second row are in the ON state, but the first pictogram TFT 51 and the second pictogram TFT 52 are in the OFF state. Therefore, during the scanning period for the second row, the first pictogram electrode 23 and the second pictogram electrode 24 are not supplied with data for display. That is, the data of the 239-th column and the data of the 240-th column read at the time T4 and the time T5, respectively, do not contribute to a display control of the first pictogram 21 and the second pictogram 22. The same goes for data for displaying the third to [L−1]-th rows. Therefore, the data of the 239-th column and the data of the 240-th column read together with the data for displaying the second to [L−1]-th rows, that is, the data of the 239-th column and the data of the 240-th column read during a scanning period for the first to [L−2]-th rows, may be taken as being undefined.

From the scanning period for the third row to the scanning period for the [L−2]-th row, the operation is the same as that during the scanning period for the second row from the time t12 to the time T6. Output signals reflecting data for displaying the [L−1]-th row read during the scanning period for the [L−2]-th row from the time T1 to the time T5 are continuously output during the scanning period for the [L−1]-th row from at the time T6 to the time T12.

During the period from the time T6 to the time T12, an output signal reflecting the data for displaying the [L−1]-th row is output from the data-side integrated circuit 26. At the same time, the data for displaying the L-th row is input to the data-side integrated circuit 26. At the time T7, data of the first column on the L-th row is input to the data-side integrated circuit 26. Then, sequentially in synchronization with each rising of data signals, data of the second column onward on the L-th row is input to the data-side integrated circuit 26. At the time T8 (omitted in FIG. 13), data of the 237-th column on the L-th row is input to the data-side integrated circuit 26. That is, from the time T7 to the time T8, the data for displaying the L-th row of the moving image display area 34 is input to the data-side integrated circuit 26. At the time T9, the time T10, and the time T11, the data of the 238-th column, 239-th column, and the 240-th column, respectively, are input to the data-side integrated circuit 26. With the data input at the time T11, data regarding the lighting of the second pictogram 22 is defined. In the example shown in FIG. 13, the data of the 240-th column input at the time T11 is “1111”, although this is not meant to be particularly restrictive.

The output signal reflecting the data for displaying the L-th row read from the time T7 to the time T11 is continuously output during the period from the time T12 to the time T18, which is a scanning period for the L-th row. During the period from the time T12 to the time T18, the 237 TFTs in the moving image display area 34 and the second pictogram TFT 52 connected to the scan line 7 on the L-th row are in the ON state. Therefore, an output signal reflecting the data read at the time T11 during the scanning period for the [L−1]-th row is supplied to the second pictogram electrode 24, thereby controlling the lighting of the second pictogram 22. On the other hand, during the period from the time T12 to the time T18, the first pictogram TFT 51 is in the OFF state. Therefore, the first pictogram electrode 23 is not supplied with data for display. That is, the data of the 239-th column read at the time T10 during the scanning period for the [L−1]-th row does not contribute to a display control of the first pictogram 21. Therefore, the data of the 239-th column read during the scanning period for the [L−1]-th row together with the data for displaying the L-th row may be taken as being undefined.

After the scanning period for the L-th row, the operation during the scanning period for the second row from the time t12 to the time T6 is applied. Therefore, the data of the 239-th column and the data of the 240-th column read after the scanning period for the L-th row may be taken as being undefined.

That is, the data of the 239-th column and the data of the 240-th column are summarized as follows. The data of the 239-th column may be taken as being undefined except the data for displaying the first row in the moving image display area 34, that is, the data immediately before the scanning period for the first row. Also, the data of the 240-th column may be taken as being undefined except the data for displaying the L-th row in the moving image display area 34, that is, the data read in the scanning period for the [L−1]-th row.

Sixth Mode

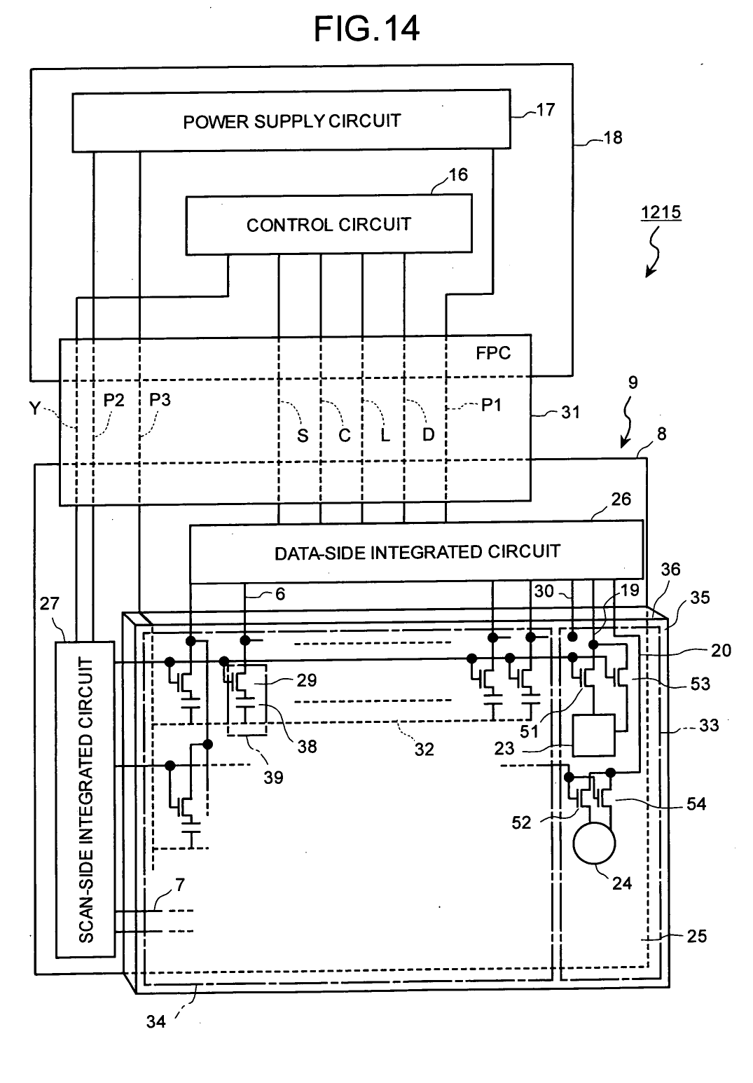

FIG. 14 is a diagram for explaining the structure of a liquid crystal display device 1215 according to the second embodiment incorporated in the portable device 10 according to the example of the present invention shown in FIGS. 1A and 1B. The liquid crystal display device 1215 according to a sixth mode has a structure in which, in the pictogram display area 33, the first pictogram electrode 23 for displaying a first pictogram is driven by the first pictogram TFT 51 and a third pictogram TFT 53 connected thereto in parallel, while the second pictogram electrode 24 for displaying a second pictogram is driven by the second pictogram TFT 52 and a fourth pictogram TFT 54 connected thereto in parallel, wherein a set of the first pictogram TFT 51 and the third pictogram TFT 53 and a set of the second pictogram TFT 52 and the fourth pictogram TFT 54 are caused to be in the ON state at different timings for each set. That is, in the structure of the fifth mode described above, the first pictogram electrode 23 and the second pictogram electrode 24 are each provided with two TFTs. Other than that, the structure of the liquid crystal display device 1215 is identical to that of the liquid crystal display device 15 (refer to FIG. 2) according to the first to third modes. Therefore, components identical to those of the liquid crystal display device 15 shown in FIG. 2 are provided with the same reference numerals, and are not described herein for avoiding redundancy.

Only the difference in structure from the fifth mode is described below. The third pictogram TFT 53 and the fourth pictogram TFT 54 are provided on the element substrate 8. The source terminal of the third pictogram TFT 53 is connected to the signal line 19, to which the source terminal of the first pictogram TFT 51 is connected. The drain terminal of the third pictogram TFT 53 is connected to the first pictogram electrode 23. The gate terminal of the third pictogram TFT 53 is connected to the scan line 7 to which the gate terminal of the first pictogram TFT 51 is connected, for example, the scan line for the first row.

The source terminal of the fourth pictogram TFT 54 is connected to the signal line 20, to which the source terminal of the second pictogram TFT 52 is connected. The drain terminal of the fourth pictogram TFT 54 is connected to the second pictogram electrode 24. The gate terminal of the fourth pictogram TFT 54 is connected to the scan line 7 to which the gate terminal of the third pictogram TFT 53 is connected, for example, the scan line for the L-th row.

In the above-described liquid crystal display device 1215, input/output timings of pictogram lighting data in the data-side integrated circuit 26 when the pictogram display area 33 is not provided with a background electrode are identical to those of the fifth mode, and therefore are not described herein.

Seventh Mode

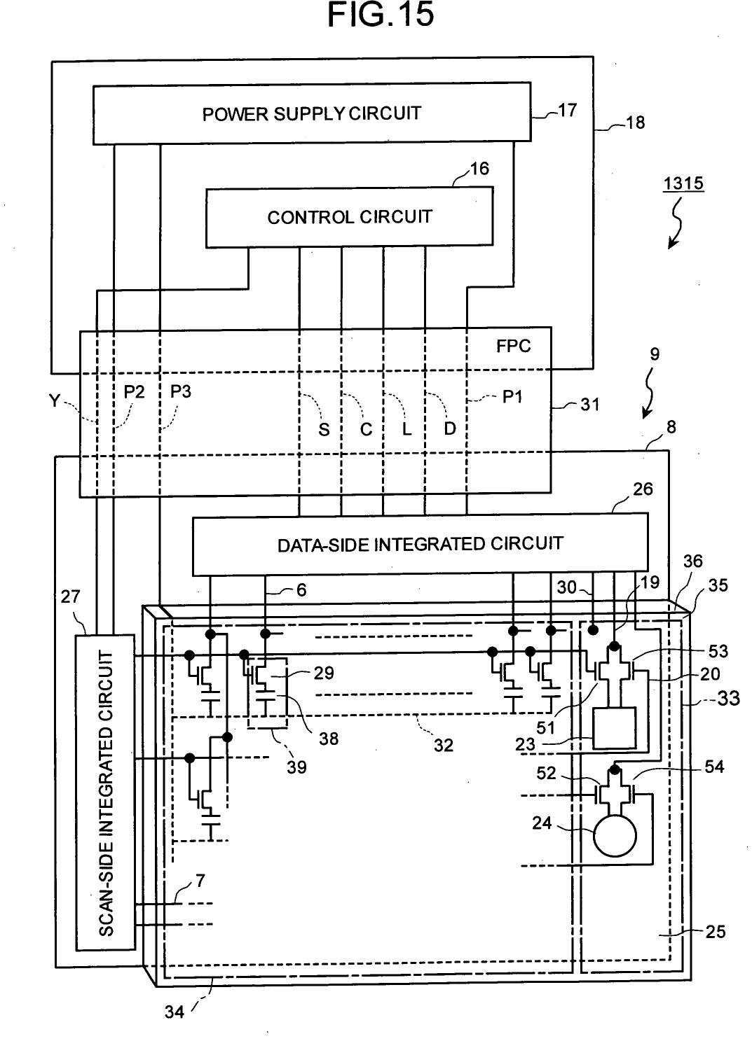

FIG. 15 is a diagram for explaining the structure of a liquid crystal display device 1315 according to the second embodiment incorporated in the portable device 10 according to the example of the present invention shown in FIGS. 1A and 1B. The liquid crystal display device 1315 according to a seventh mode has a structure in which, in the pictogram display area 33, the first pictogram electrode 23 for displaying a first pictogram is driven by the first pictogram TFT 51 and the third pictogram TFT 53, while the second pictogram electrode 24 for displaying a second pictogram is driven by the second pictogram TFT 52 and the fourth pictogram TFT 54, wherein the first pictogram TFT 51 and the third pictogram TFT 53 are caused to be in the ON state at different timings, and the second pictogram TFT 52 and the fourth pictogram TFT 54 are caused to be in the ON state at different timings. That is, in the structure of the sixth mode described above, the gate terminal of the first pictogram TFT 51 and the gate terminal of the third pictogram TFT 53 are connected to different electrodes in the scan-side integrated circuit 27, while the gate terminal of the second pictogram TFT 52 and the gate terminal of the fourth pictogram TFT 54 are connected to different electrodes in the scan-side integrated circuit 27. Other than that, the structure of the liquid crystal display device 1315 is identical to that of the liquid crystal display device 15 (refer to FIG. 2) according to the first to third modes. Therefore, components identical to those of the liquid crystal display device 15 shown in FIG. 2 are provided with the same reference numerals, and are not described herein for avoiding redundancy.

Hereinafter, only the difference in structure from the sixth mode is described. The source terminal of the third pictogram TFT 53 is connected to the signal line 19, to which the source terminal of the first pictogram TFT 51 is connected. The drain terminal of the third pictogram TFT 53 is connected to the first pictogram electrode 23. The gate terminal of the third pictogram TFT 53 is connected to a scan line 7 that is different from the scan line 7 on the first row to which the gate terminal of the first pictogram TFT 51 is connected, for example, a scan line for a K-th (in the present embodiment, K is an integer from 2 to 120) line. To the scan line 7 on the K-th row, the gate terminals of the 237 TFTs 29 arranged in the K-th row in the moving image display area 34 are also connected.

The source terminal of the fourth pictogram TFT 54 is connected to the signal line 20, to which the source terminal of the second pictogram TFT 52 is connected. The drain terminal of the fourth pictogram TFT 54 is connected to the second pictogram electrode 24. The gate terminal of the fourth pictogram TFT 54 is connected to a scan line that is different from the scan line 7 to which the gate terminal of the third pictogram TFT 53 is connected, for example, a scan line for the M-th (in the present embodiment, M is an integer from 2 to 120) line. To the scan line 7 on the M-th row, the gate terminals of the 237 TFTs 29 arranged in the M-th row in the moving image display area 34 are also connected.

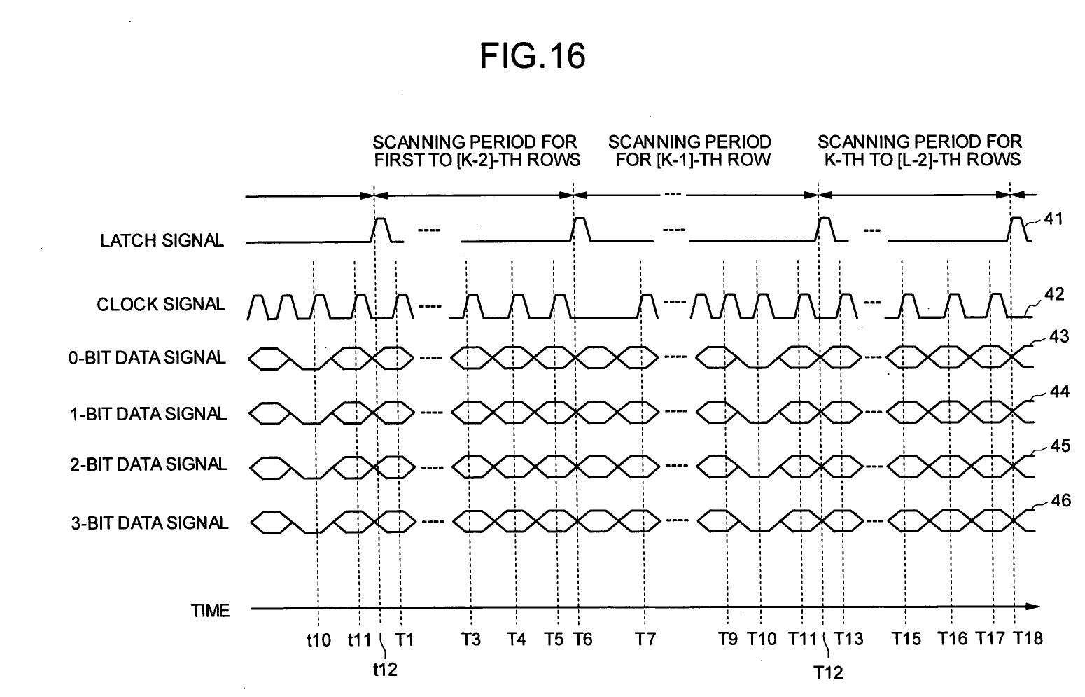

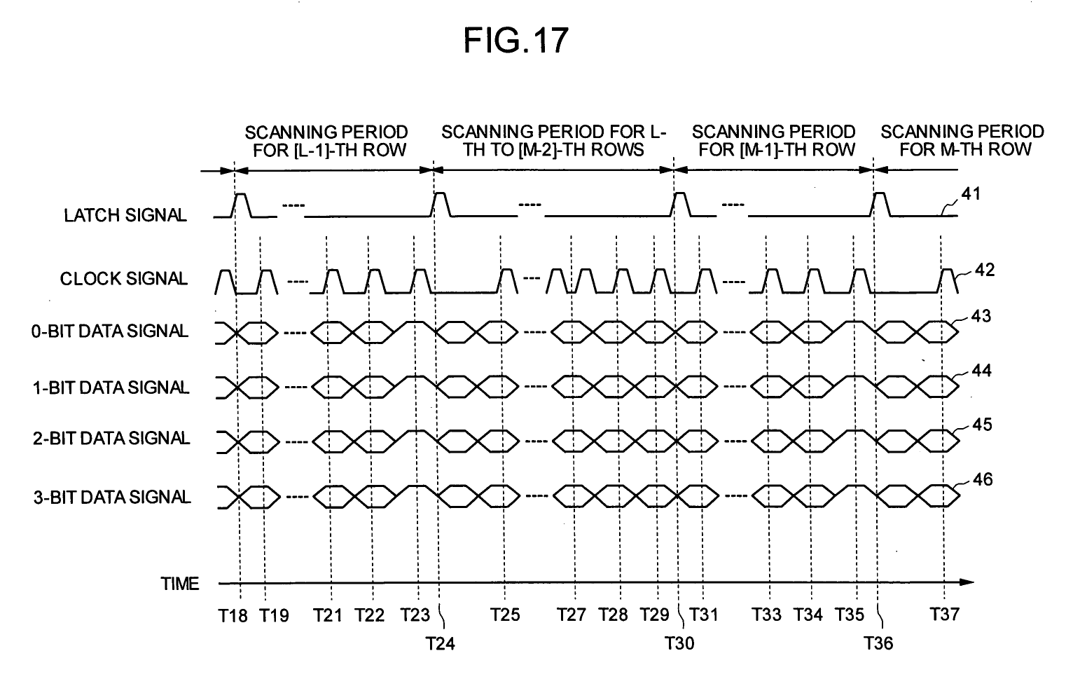

Next, the operation of the liquid crystal display device 1315 having the structure described above is described according to timing charts shown in FIGS. 16 and 17. The liquid crystal display device 1315 of the seventh mode is not provided with a background electrode in the pictogram display area 33. FIG. 16 and FIG. 17 are timing charts showing input/output timings for explaining pictogram lighting of the data-side integrated circuit 26.

As shown in FIG. 16, data for displaying the first row is input to the data-side integrated circuit 26 immediately before the scanning period for the first row. At the time t10 during the period in which the data for displaying the line is input, data of the 239-th column is input to the data-side integrated circuit 26. At the time t11, data of the 240-th column is input to the data-side integrated circuit 26. That is, at the time t10, data regarding the lighting of the first pictogram 21 is defined. In the example of FIG. 16, the data of the 239-th column input at a time t10 is “0000”, although this is not meant to be particularly restrictive.

An output signal reflecting the data for displaying the first row read by the time t11 is continuously output during a period from the time t12 to the time T6, which is the scanning period for the first row. During the period from the time t12 and the time T6, the 237 TFTs in the moving image display area 34 and the first pictogram TFT 51 connected to the scan line 7 on the first row are in the ON state. Therefore, an output signal reflecting the data read at the time t10 is supplied to the first pictogram electrode 23, thereby controlling the lighting of the first pictogram 21. On the other hand, during the period from the time t12 to the time T6, the second pictogram TFT 52 is in the OFF state. Therefore, data for display is not supplied to the second pictogram electrode 24. That is, the data of the 240-th column read at the time t11 does not contribute a display control of the second pictogram 22. Therefore, the data of the 240-th column read together with the data for displaying the first row may be undefined.

During the period from the time t12 to the time T6, an output signal reflecting the data for displaying the first row is output from the data-side integrated circuit 26. At the same time, data for displaying the second row is input to the data-side integrated circuit 26. At the time T1, data of the first column on the second row is input to the data-side integrated circuit 26. Then, sequentially in synchronization with each rising of data signals, data of the second column onward on the second row is input to the data-side integrated circuit 26. At the time T2 (omitted in FIG. 16), data of the 237-th column on the second row is input to the data-side integrated circuit 26. That is, from the time T1 to the time T2, data for displaying the second row in the moving image display area 34 is input to the data-side integrated circuit 26. At the time T3, the time T4, and the time T5, data of the 238-th column, the 239-th column, and the 240-th column, respectively, are input to the data-side integrated circuit 26.

Output signals reflecting the data for displaying the second row read from the time T1 to the time T2, the time T3, the time T4, and the time T5 during the scanning period for the first row are continuously output during a scanning period for the second row from the time t12 to the time T6 (in FIG. 16, collectively represented by a scanning period for the first to [K−2]-th rows). However, during the scanning period for the second row from the time t12 to the time T6, the 237 TFTs in the moving image display area 34 connected to the scan line 7 on the second row are in the ON state, while the first pictogram TFT 51 and the second pictogram TFT 52 are in the OFF state. Therefore, during the scanning period for the second row, the first pictogram electrode 23 and the second pictogram electrode 24 are not supplied with data for display. That is, the data of the 239-th column read at the time T4 and the data of the 240-th column read at the time T5 during the scanning period for the first row do not contribute to a display control of the first pictogram 21 and the second pictogram 22. The same goes for data for displaying the third to [K−1]-th rows. Therefore, the data of the 239-th column and the data of the 240-th column read together with the data for displaying the second to [K−1]-th rows, that is, the data of the 239-th column and the data of the 240-th column read from the scanning period for the first row to the scanning period for the [K−2]-th row, may be taken as being undefined.

The operation from the scanning period for the third row to the scanning period for the [K−2]-th row is the same as that from the scanning period for the second row from the time t12 to the time T6. An output signal reflecting data for displaying the [K−1]-th row read during a scanning period for the [K−2]-th from the time T1 to the time T5 is continuously output during a scanning period for the [K−1]-th row from the time T6 to the time T12.

During the period from the time T6 to the time T12, an output signal reflecting the data for display the [K−1]-th row is output from the data-side integrated circuit 26. At the same time, data for displaying the K-th row is input to the data-side integrated circuit 26. At the time T7, data of the first column on the K-th row is input to the data-side integrated circuit 26. Then, sequentially in synchronization with each rising of data signals, data of the second column onward on the K-th row is input to the data-side integrated circuit 26. At the time T8 (omitted in FIG. 16), data of the 237-th column on the K-th row is input to the data-side integrated circuit 26. That is, from the time T7 to the time T8, data for displaying the K-th row in the moving image display area 34 is input to the data-side integrated circuit 26. At the time T9, the time T10, and the time 11, data of the 238-th column, the 239-th column, and the 240-th column, respectively, are input to the data-side integrated circuit 26. With the data input at the time T10, data regarding the lighting of the first pictogram 21 is defined. In the example of FIG. 16, the data of the 239-th column input at the time T10 is “0000”, although this is not meant to be particularly restrictive.

Output signals reflecting the data for displaying the K-th row read from the time T7 to the time T11 are continuously output during a scanning period for the K-th row from the time T12 to the time T18. From the time T12 to the time T18 in the scanning period for the K-th row the 237 TFTs in the moving image display area 34 and the first pictogram TFT 51 connected to the scan line 7 on the K-th row are in the ON state. Therefore, output signals reflecting the data read at the time T10 in the scanning period for the [K−1]-th row are supplied to the first pictogram electrode 23, thereby controlling the lighting of the first pictogram 21. On the other hand, from the time T12 to the time T18 during the scanning period for the K-th row, the second pictogram TFT 52 is in the OFF state. Therefore, the second pictogram electrode 24 is not supplied with data for display. That is, the data of the 240-th column read at the time T11 in the scanning period for the [K−1]-th row does not contribute to a display control of the second pictogram 22. Therefore, the data of the 240-th column read together with the data for displaying the K-th row during the scanning period for the [K−1]-th row may be taken as being undefined.

During the period from the time T12 to the time T18, an output signal reflecting the data for displaying the K-th row is output from the data-side integrated circuit 26. At the same time, data for displaying a [K+1]-th row is input to the data-side integrated circuit 26. At the time T13, data of the first column on a [K+1]-th row is input to the data-side integrated circuit 26. Then, sequentially in synchronization with each rising of data signals, data of the second column onward on the [K+1]-th row is input to the data-side integrated circuit 26. At the time T14 (omitted in FIG. 16), data of the 237-th column on the [K+1]-th row is input to the data-side integrated circuit 26. That is, from the time T13 to the time T14, data for displaying the [K+1]-th row in the moving image display area 34 is input to the data-side integrated circuit 26. At the time T15, the time T16, and the time 17, data of the 238-th column, the 239-th column, and the 240-th column, respectively, are input to the data-side integrated circuit 26.

Output signals reflecting the data for displaying the [K+1]-th row read from the time T13 to the time T17 are continuously output during a scanning period for the [K+1]-th row (in FIG. 16, collectively represented by a scanning period for the K-th to [L−2]-th rows) from the time T12 to the time T18. However, during the scanning period for the [K+1]-th row, the 237 TFTs in the moving image display area 34 connected to the scan line 7 on the [K+1]-th row is in the ON state, while the first pictogram TFT 51 and the second pictogram TFT 52 are in the OFF state. Therefore, during the scanning period for the [K+1]-th row, the first pictogram electrode 23 and the second pictogram electrode 24 are not supplied with data for display. That is, the data of the 239-th column read at the time T16 and the data of the 240-th column read at the time T17 in the scanning period for the K-th row do not contribute to a display control of the first pictogram 21 and the second pictogram 22. The same goes for data for displaying the line thereafter to the [L−1]-th row. Therefore, the data of the 239-th column and the data of the 240-th column read together with the data for displaying the [K+1]-th to [L−1]-th rows, that is, the data of the 239-th column and the data of the 240-th column read from the scanning period for the K-th row to the scanning period for the [L−2]-th row, may be taken as being undefined.

The operation from the scanning period for the [K+2]-th row to the scanning period for the [L−2]-th row is the same as that from the time T12 to a time T18 in the scanning period for the [K+1]-th row. Output signals reflecting the data for displaying the [L−1]-th row read from the time T13 to a time T17 in the scanning period for the [L−2]-th row are continuously output from the time T18 to a time T24 in the scanning period for the [L−1]-th row in FIG. 17.

During the period from the time T18 to the time T24, an output signal reflecting the data for displaying the [L−1]-th row is output from the data-side integrated circuit 26. At the same time, data for displaying a L-th row is input to the data-side integrated circuit 26. At the time T19, data of the first column on the L-th row is input to the data-side integrated circuit 26. Then, sequentially in synchronization with each rising of data signals, data of the second column onward on the L-th row is input to the data-side integrated circuit 26. At the time T20 (omitted in FIG. 17), data of the 237-th column on the L-th row is input to the data-side integrated circuit 26. That is, from the time T19 to the time T20, data for displaying the L-th row in the moving image display area 34 is input to the data-side integrated circuit 26. At the time T21, the time T22, and the time T23, data of the 238-th column, the 239-th column, and the 240-th column, respectively, are input to the data-side integrated circuit 26. With the data input at the time T23, data regarding the lighting of the second pictogram 22 is defined. In the example shown in FIG. 17, data of the 240-th column input at the time T23 is “1111”, although this is not meant to be particularly restrictive.

Output signals reflecting the data for displaying the L-th row read from the time T19 to the time T23 are continuously output from a time T24 to a time T30. During the scanning period for the L-th row from the time T24 to the time T30, the 237 TFTs and the second pictogram TFT 52 in the moving image display area 34 connected to the scan line 7 on the L-th row are in the ON state. Therefore, an output signal reflecting the data read at the time T23 in the scanning period for the [L−1]-th row is supplied to the second pictogram electrode 24, thereby controlling the lighting of the second pictogram 22. On the other hand, during the scanning period for the L-th row from the time T24 to the time T30, the first pictogram TFT 51 is in the OFF state. Therefore, the first pictogram electrode 23 is not supplied with data for display. That is, the data of the 239-th column read at the time T22 in the scanning period for the [L−1]-th row does not contribute to a display control of the first pictogram 21. Therefore, the data of the 239-th column read together with the data for displaying the L-th row in the scanning period for the [L−1]-th row may be taken as being undefined.

During the period from the time T24 to the time T30, an output signal reflecting the data for displaying the L-th row is output from the data-side integrated circuit 26. At the same time, data for displaying the [L+1]-th row is input to the data-side integrated circuit 26. At the time T25, data of the first column on the [L+1]-th row is input to the data-side integrated circuit 26. Then, sequentially in synchronization with each rising of data signals, data of the second column onward on the [L+1]-th row is input to the data-side integrated circuit 26. At a time T26 (omitted in FIG. 17), data of the 237-th column on the [L+1]-th row is input to the data-side integrated circuit 26. That is, from the time T25 to the time T26, data for displaying the [L+1]-th row in the moving image display area 34 is input to the data-side integrated circuit 26. At the time T27, the time T28, and the time T29, data of the 238-th column, the 239-th column, and the 240-th column, respectively, are input to the data-side integrated circuit 26.

Output signals reflecting the data for displaying the [L+1]-th row read from the time T25 to the time T29 are continuously output during the scanning period for the [L+1]-th row (in FIG. 17, collectively represented by a scanning period from the L-th to [M−2]-th rows) from the time T24 to the time T30. However, during the scanning period for the [L+1]-th row, the 237 TFTs in the moving image display area 34 connected to the scan line 7 on the [L+1]-th row are in the ON state, but the first pictogram TFT 51 and the second pictogram TFT 52 are in the OFF state. Therefore, during the scanning period for the [L+1]-th row, the first pictogram electrode 23 and the second pictogram electrode 24 are not supplied with data for display. That is, the data of the 239-th column and the data of the 240-th column read at the time T28 and the time T29, respectively, in the scanning period for the L-th row do not contribute to a display control of the first pictogram 21 and the second pictogram 22. The same goes for data for displaying lines thereafter until an [M−1]-th row. Therefore, the data of the 239-th column and the data of the 240-th column read together with the data for displaying lines from the [L+1]-th to [M−1]-th rows, that is, the data of the 239-th column and the data of the 240-th column read from the scanning period for the L-th row to the scanning period for the [M−2]-th row, may be taken as being undefined.

The operation from the scanning period for the [L+2]-th row to the scanning period for the [M−2]-th row is the same as that from the time T24 to the time T30 in the scanning period for the [L+1]-th row. Output signals reflecting the data for displaying the [M−1]-th row read from the time T25 to the time T29 in the scanning period for the [M−2]-th row are continuously output from the time T30 to a time T36 in the scanning period for the [M−1]-th row.

During the period from the time T30 to the time T36, an output signal reflecting the data for displaying the [M−1]-th row is output from the data-side integrated circuit 26. At the same time, data for displaying the M-th row is input to the data-side integrated circuit 26. At the time T31, data of the first column on the M-th row is input to the data-side integrated circuit 26. Then, sequentially in synchronization with each rising of data signals, data of the second column onward on the M-th row is input to the data-side integrated circuit 26. At the time T32 (omitted in FIG. 17), data of the 237-th column on the M-th row is input to the data-side integrated circuit 26. That is, from the time T31 to the time T32, data for displaying the M-th row in the moving image display area 34 is input to the data-side integrated circuit 26. At the time T33, the time T34, and the time T35, data of the 238-th column, the 239-th column, and the 240-th column, respectively, are input to the data-side integrated circuit 26. With the data input at the time T35, data regarding the lighting of the second pictogram 22 is defined. In the example shown in FIG. 17, data of the 240-th column input at the time T35 is “1111”, although this is not meant to be particularly restrictive.

Output signals reflecting the data for displaying the M-th row read from the time T31 to the time T35 are output after a time T36 in a scanning period for an M-th row. During the scanning period for the M-th row, the 237 TFTs in the moving image display area 34 and the second pictogram TFT 52 connected to the scan line 7 on the M-th row are in the ON state. Therefore, an output signal reflecting the data read at the time T35 in the scanning period for the [M−1]-th row is supplied to the second pictogram electrode 24, thereby controlling the lighting of the second pictogram 22. On the other hand, during the scanning period for the M-th row, the first pictogram TFT 51 is in the OFF state. Therefore, the first pictogram electrode 23 is not supplied with data for display. That is, the data of the 239-th column read at the time T34 in the scanning period for the [M−1]-th row does not contribute to a display control of the first pictogram 21. Therefore, the data of the 239-th column read in the scanning period for the [M−1]-th row together with the data for displaying the M-th row may be taken as being undefined.

The operation in the scanning period for the M-th row and thereafter is the same as that of the scanning period for the [L+1]-th row at the time T24 to the time T30. Therefore, the data of the 239-th column and the data of the 240-th column read in the scanning period for the M-th row and thereafter may be taken as being undefined.

That is, the data of the 239-th column and the data of the 240-th column are summarized as follows. The data of the 239-th column may be taken as being undefined except the data for displaying the first row and the K-th row in the moving image display area 34, that is, the data read immediately before the scanning period for the first row and the data read in the scanning period for the [K−1]-th row. Also, the data of the 240-th column may be taken as being undefined except the data for displaying the L-th row and the M-th row in the moving image display area 34, that is, the data read in the scanning period for the [L−1]-th row and the data read in the scanning period for the [M−1]-th row.

Eighth Mode

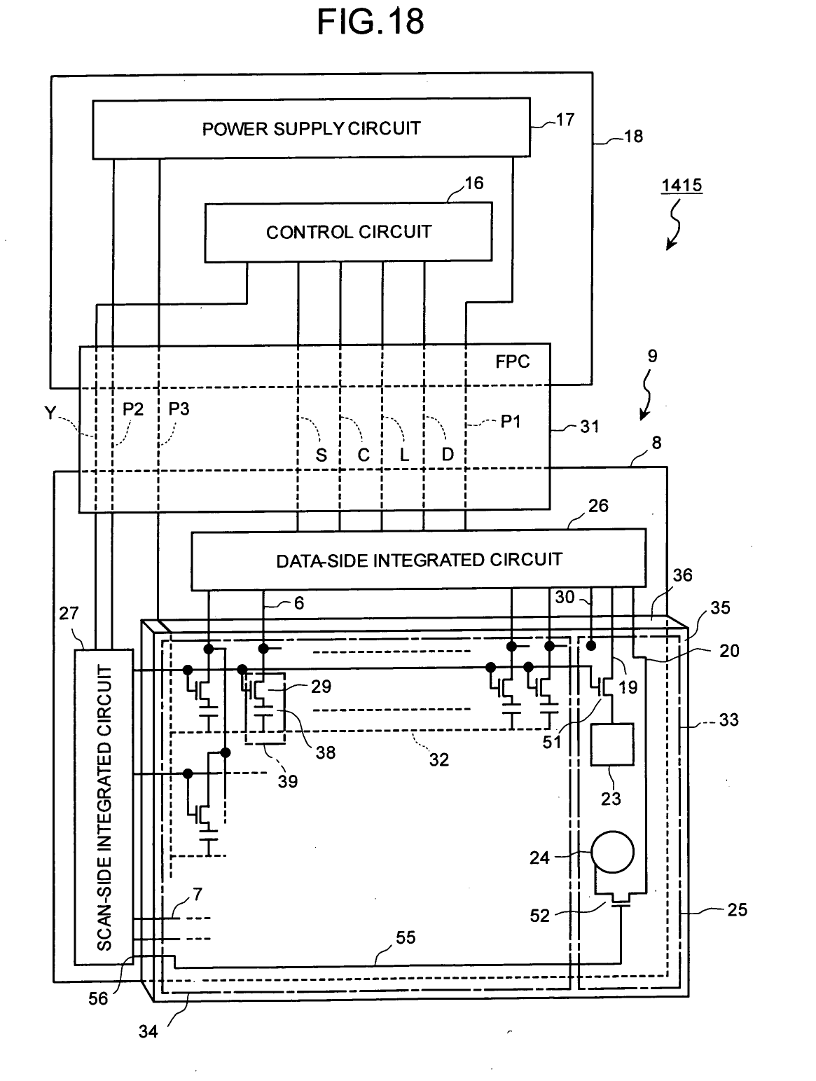

FIG. 18 is a diagram for explaining the structure of a liquid crystal display device 1415 according to the second embodiment incorporated in the portable device 10 according to the example of the present invention shown in FIGS. 1A and 1B. The liquid crystal display device 1415 according to an eighth mode has a structure in which, in the pictogram display area 33, the first pictogram electrode 23 for displaying the first pictogram is driven by the first pictogram TFT 51, while the second pictogram electrode 24 for displaying the second pictogram is driven by the second pictogram TFT 52, wherein the pictogram TFTs are caused to be in the ON state at a timing different from that of the TFTs 29 in the moving image display area 34. That is, in the structure of the fifth mode described above, the gate terminal of the second pictogram TFT 52 is connected to an electrode that is different from the electrodes to which the 120 scan lines 7 connected to the TFTs 29 of the moving image display area 34 (such an electrode is hereinafter referred to as an extra terminal) in the scan-side integrated circuit 27. Other than that, the structure of the liquid crystal display device 1415 is identical to that of the liquid crystal display device 15 (refer to FIG. 2) according to the first to third modes. Therefore, components identical to those of the liquid crystal display device 15 shown in FIG. 2 are provided with the same reference numerals, and are not described herein for avoiding redundancy.

Hereinafter, only the difference in structure from the fifth mode is described. The gate terminal of the second pictogram TFT 52 is connected to a scan line 55 that is different from the 120 scan lines 7 connected to the TFTs 29 of the moving image display area 34. This scan line 55 is routed in the rim of the element substrate 8, for example, and is connected to an extra terminal 56 in the scan-side integrated circuit 27.

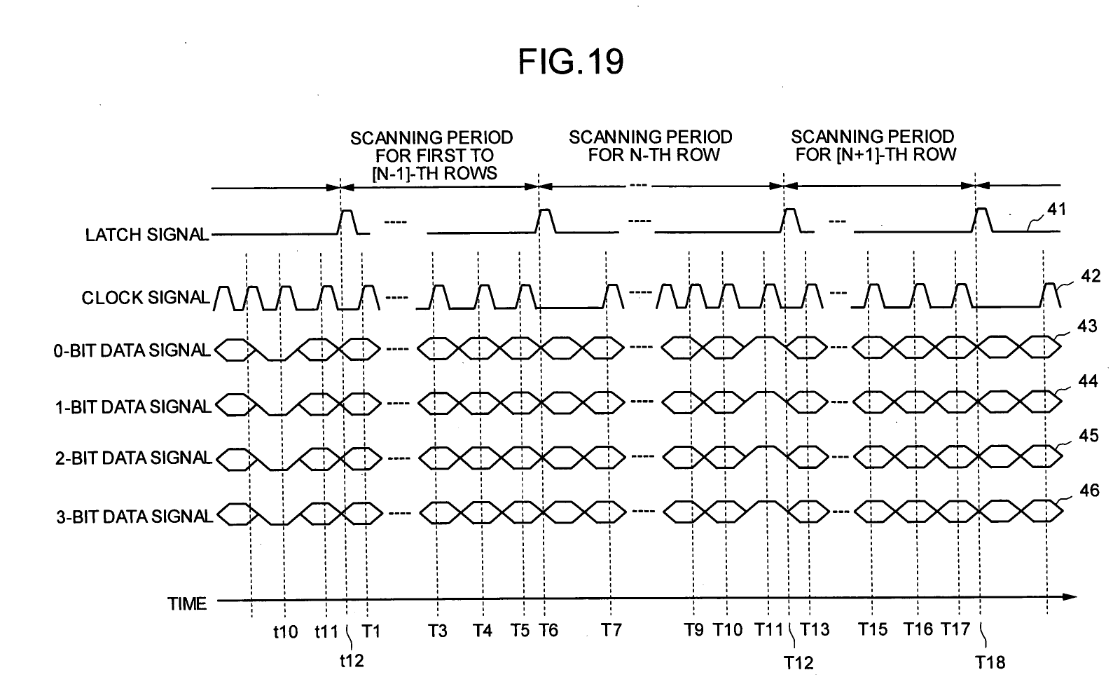

Next, the operation of the liquid crystal display device 1415 having the structure described above is described according to a timing chart shown in FIG. 19. The liquid crystal display device 1415 of the eighth mode is not provided with a background electrode in the pictogram display area 33. FIG. 19 is a timing chart showing input/output timings for explaining pictogram lighting of the data-side integrated circuit 26. In the description of this timing chart, it is assumed that N is an integer equal to or larger than 120. Also, in the present embodiment, there is no 121-th row onward in the moving image display area 34. However, for convenience of description, it is assumed that the extra terminal 56 in the scan-side integrated circuit 27 to which the gate terminal of the second pictogram TFT 52 is connected via the scan line 55 is connected is a terminal for an [N+1]-th row.

As shown in FIG. 19, data for displaying the first row is input to the data-side integrated circuit 26 immediately before the scanning period for the first row. At the time t10 in the period in which the data for displaying the first row is input, data of the 239-th column is input to the data-side integrated circuit 26. At the time t11, data of the 240-th column is input to the data-side integrated circuit 26. That is, at the time t10, data regarding the lighting of the first pictogram 21 is defined. In the example of FIG. 19, the data of the 239-th column input at the time t10 is “0000”, which is not meant to be particularly restrictive.

An output signal reflecting the data for displaying the first row read by the time t11 is continuously output during the scanning period for the first row from the time t12 to the time T6. During the period from the time t12 to the time T6, the 237 TFTs in the moving image display area 34 connected to the scan line 7 on the first row and the first pictogram TFT 51 are in the ON state. Therefore, an output signal reflecting the data read at the time t10 is supplied to the first pictogram electrode 23, thereby controlling the lighting of the first pictogram 21. On the other hand, during the scanning period from the time t12 to the time T6, the second pictogram TFT 52 is in the OFF state. Therefore, the second pictogram electrode 24 is not supplied with data for display. That is, the data of the 240-th column read at the time t11 does not contribute to a display control of the second pictogram 22. Therefore, the data of the 240-th column read together with the data for displaying the first row may be taken as being undefined.

During the scanning period for the first row from the time t12 to the time T6, an output signal reflecting the data for displaying the first row is output from the data-side integrated circuit 26. At the same time, data for displaying the second row is input to the data-side integrated circuit 26. At the time T1, data of the first column on the second row is input to the data-side integrated circuit 26. Then, sequentially in synchronization with each rising of data signals, data of the second column onward on the second row is input to the data-side integrated circuit 26. At the time T2 (omitted in FIG. 19), data of the 237-th column on the second row is input to the data-side integrated circuit 26. That is, from the time T1 to the time T2, data for displaying the second row in the moving image display area 34 is input to the data-side integrated circuit 26. At the time T3, the time T4, and the time T5, data of the 238-th column, the 239-th column, and the 240-th column, respectively, are input to the data-side integrated circuit 26.

An output signal reflecting the data for displaying the second row read from the time T1 to the time T2, the time T3, the time T4, and the time T5 in the scanning period for the first row is continuously output during the scanning period for the second row from the time t12 to the time T6, (in FIG. 19, collectively represented by a scanning period from the first to [N−1]-th rows). However, during the scanning period for the second row from the time t12 to the time T6, the 237 TFTs in the moving image display area 34 connected to the scan line 7 on the second row are in the ON state, but the first pictogram TFT 51 and the second pictogram TFT 52 are in the OFF state. Therefore, during the scanning period for the second row, the first pictogram electrode 23 and the second pictogram electrode 24 are not supplied with data for display. That is, the data of the 239-th column and the data of the 240-th column read at the time T4 and the time T5, respectively, in the scanning period for the first row do not contribute to a display control of the first pictogram 21 and the second pictogram 22. The same goes for data for displaying the third to N-th rows. Therefore, the data of the 239-th column and the data of the 240-th column read together with the data for displaying the second to N-th rows, that is, data of the 239-th column and data of the 240-th column read during a scanning period for the first to [N−1]-th rows, may be taken as being undefined.

From the scanning period for the third row to the scanning period for the [N−1]-th row, the operation is the same as that during the scanning period for the second row from the time t12 to the time T6. An output signal reflecting data for displaying the N-th row read during the scanning period for the [N−1]-th row from the time T1 to the time T5 is continuously output during the scanning period for the N-th row at the time T6 to the time T12.

During the period from the time T6 to the time T12, an output signal reflecting the data for displaying the N-th row is output from the data-side integrated circuit 26. At the same time, an output signal reflecting the data for displaying the [N+1]-th row is input to the data-side integrated circuit 26. At the time T7, data of the first column on the [N+1]-th row is input to the data-side integrated circuit 26. Then, sequentially in synchronization with each rising of data signals, data of the second column onward on the [N+1]-th row is input to the data-side integrated circuit 26. At the time T8 (omitted in FIG. 19), data of the 237-th column on the [N+1]-th row is input to the data-side integrated circuit 26. That is, from the time T7 to the time T8, the data for displaying the [N+1]-th row in the moving image display area 34 is input to the data-side integrated circuit 26. At the time T9, the time T10, and the time T11, the data of the 238-th column, 239-th column, and the 240-th column, respectively, are input to the data-side integrated circuit 26. With the data input at the time T11, data regarding the lighting of the second pictogram 22 is defined. In the example shown in FIG. 19, data of the 240-th column input at the time T11 is “1111”, although this is not meant to be particularly restrictive.

An output signal reflecting the data for displaying the [N+1]-th row read from the time T7 to the time T11 is continuously output during a scanning period for the [N+1]-th row from the time T12 to the time T18. During the period from the time T12 to the time T18, the 237 TFTs in the moving image display area 34 and the second pictogram TFT 52 connected to the scan line 7 on the [N+1]-th row are in the ON state. Therefore, an output signal reflecting the data read at the time T11 during the scanning period for the N-th row is supplied to the second pictogram electrode 24, thereby controlling the lighting of the second pictogram 22. On the other hand, during the period from the time T12 to the time T18, the first pictogram TFT 51 is in the OFF state. Therefore, the first pictogram TFT 51 is not supplied with data for display. That is, the data of the 239-th column read at the time T10 during the scanning period for the N-th row does not contribute to a display control of the first pictogram 21. Therefore, the data of the 239-th column read during the scanning period for the N-th row together with the data for displaying the [N+1]-th row may be taken as being undefined.

After the scanning period for the [N+1]-th row, the operation is the same as that during the scanning period for the second row from the time t12 to the time T6. Therefore, the data of the 239-th column and the data of the 240-th column read after the scanning period for the [N+1]-th row may be taken as being undefined.

That is, the data of the 239-th column and the data of the 240-th column are summarized as follows. The data of the 239-th column may be taken as being undefined except the data for displaying the first row in the moving image display area 34, that is, the data read immediately before the scanning period for the first row. Also, the data of the 240-th column may be taken as being undefined except the data for displaying the [N+1]-th row of the moving image display area 34, that is, the data read in the scanning period for the N-th row.

The structure may be such that the gate terminal of the first pictogram TFT 51 is connected to the extra terminal 56 in the scan-side integrated circuit 27 to which the gate terminal of the second pictogram TFT 52 is connected, or is connected to an extra terminal that is different from the extra terminal 56 to which the gate terminal of the second pictogram TFT 52 is connected.

Ninth Mode

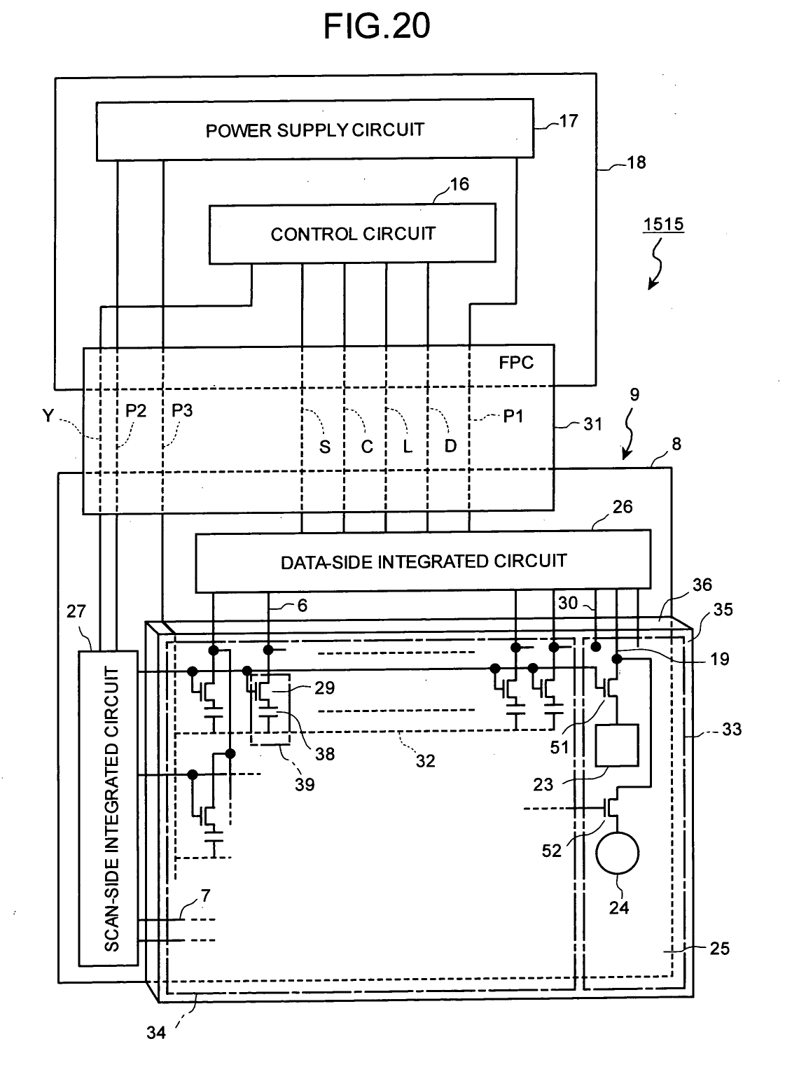

FIG. 20 is a diagram for explaining the structure of a liquid crystal display device 1515 according to the second embodiment incorporated in the portable device 10 according to the example of the present invention shown in FIGS. 1A and 1B. The liquid crystal display device 1515 according to a ninth mode has a structure in which, in the pictogram display area 33, the first pictogram electrode 23 for displaying the first pictogram is driven by the first pictogram TFT 51, while the second pictogram electrode 24 for displaying the second pictogram is driven by the second pictogram TFT 52, wherein the first pictogram TFT 51 and the second pictogram TFT 52 are connected to the same electrode of the data-side integrated circuit 26, and also the first pictogram TFT 51 and the second pictogram TFT 52 are caused to be in the ON state at different timings. That is, in the structure of the fifth mode described above, the source terminal of the second pictogram TFT 52 is connected to the signal line 19, to which the source terminal of the first pictogram TFT 51 is connected. Other than that, the structure of the liquid crystal display device 1515 is identical to that of the liquid crystal display device 15 (refer to FIG. 2) according to the first to third modes. Therefore, components identical to those of the liquid crystal display device 15 shown in FIG. 2 are provided with the same reference numerals, and are not described herein for avoiding redundancy.

Hereinafter, only the difference in structure from the fifth mode is described. The first pictogram TFT 51 and the second pictogram TFT 52 are supplied with data from the same electrode of the data-side integrated circuit 26. When the first pictogram TFT 51 becomes in the ON state (the second pictogram TFT 52 is in the OFF state), the data-side integrated circuit 26 outputs data regarding the lighting of the first pictogram 21 to the electrode to which the first pictogram TFT 51 and the second pictogram TFT 52 are connected. Also, when the second pictogram TFT 52 becomes in the ON state (the first pictogram TFT 51 is in the OFF state), the data-side integrated circuit 26 outputs data regarding the lighting of the second pictogram 22 to the electrode to which the first pictogram TFT 51 and the second pictogram TFT 52 are connected.

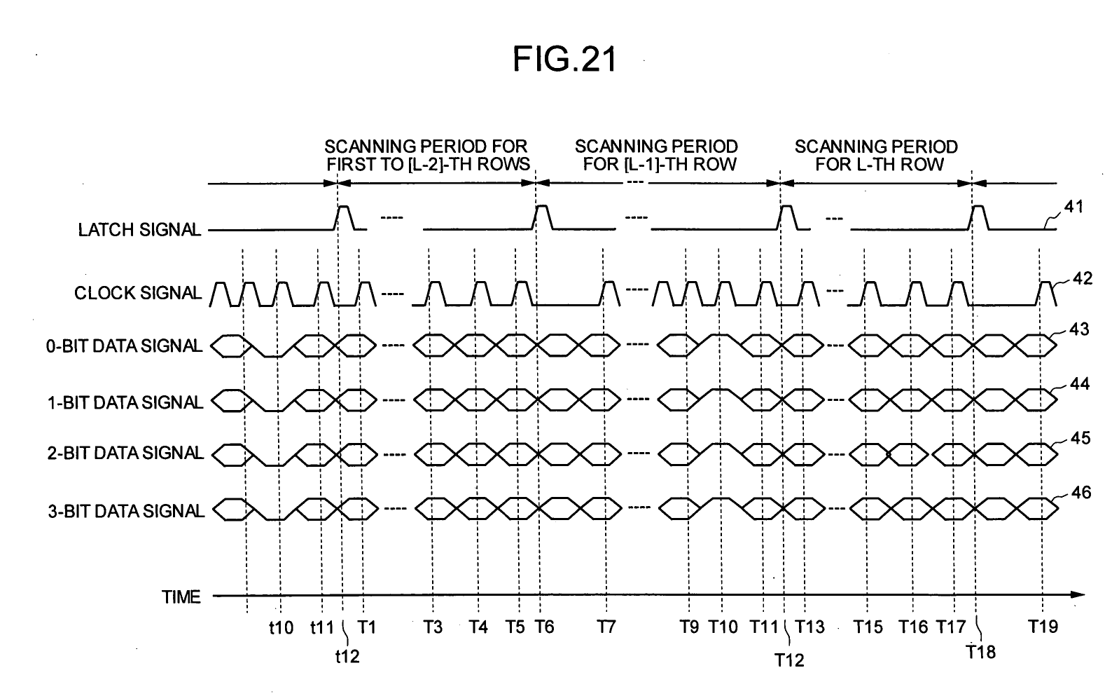

Next, the operation of the liquid crystal display device 1515 having the structure described above is described according to a timing chart shown in FIG. 21. The liquid crystal display device 1515 of the ninth mode is not provided with a background electrode in the pictogram display area 33. FIG. 21 is a timing chart showing input/output timings for explaining pictogram lighting of the data-side integrated circuit 26.

As shown in FIG. 21, data for displaying the first row is input to the data-side integrated circuit 26 immediately before the scanning period for the first row. At the time t10 in the period in which the data for displaying the first row is input, data of the 239-th column is input to the data-side integrated circuit 26. At the time t11, data of the 240-th column is input to the data-side integrated circuit 26. That is, at the time t10, data regarding the lighting of the first pictogram 21 is defined. In the example of FIG. 21, the data of the 239-th column input at the time t10 is “0000”, which is not meant to be particularly restrictive. In the ninth mode, the data of the 240-th column is always undefined.

An output signal reflecting the data for displaying the first row read by the time t11 is continuously output during the scanning period for the first row from the time t12 to the time T6. During the period from the time t12 to the time T6, the 237 TFTs in the moving image display area 34 and the first pictogram TFT 51 connected to the scan line 7 on the first row are in the ON state. Therefore, an output signal reflecting the data read at the time t10 is supplied to the first pictogram electrode 23, thereby controlling the lighting of the first pictogram 21.

During the scanning period for the first row from the time t12 to the time T6, an output signal reflecting the data for displaying the first row is output from the data-side integrated circuit 26. At the same time, data for displaying the second row is input to the data-side integrated circuit 26. At the time T1, data of the first column on the second row is input to the data-side integrated circuit 26. Then, sequentially in synchronization with each rising of data signals, data of the second column onward on the second row is input to the data-side integrated circuit 26. At the time T2 (omitted in FIG. 21), data of the 237-th column on the second row is input to the data-side integrated circuit 26. That is, from the time T1 to the time T2, data for displaying the second row in the moving image display area 34 is input to the data-side integrated circuit 26. At the time T3, the time T4, and the time T5, data of the 238-th column, the 239-th column, and the 240-th column, respectively, are input to the data-side integrated circuit 26.

An output signal reflecting the data for displaying the second row read from the time T1 to the time T2, the time T3, the time T4, and the time T5 in the scanning period for the first row is continuously output during the scanning period for the second row from the time t12 to the time T6 (in FIG. 21, collectively represented by a scanning period for the first to [L−2]-th rows). However, during the scanning period for the second row from the time t12 to the time T6, the 237 TFTs in the moving image display area 34 connected to the scan line 7 on the second row are in the ON state, but the first pictogram TFT 51 and the second pictogram TFT 52 are in the OFF state. Therefore, during the scanning period for the second row, the first pictogram electrode 23 and the second pictogram electrode 24 are not supplied with data for display. That is, the data of the 239-th column at the time T4 in the scanning period for the first row does not contribute to a display control of the first pictogram 21 and the second pictogram 22. The same goes for data for displaying the third to [L−1]-th rows. Therefore, the data of the 239-th column read together with the data for displaying the second to [L−1]-th rows, that is, the data of the 239-th column read during the scanning period for the first row to the scanning period for the [L−2]-th row, may be taken as being undefined.

From the scanning period for the third row to the scanning period for the [L−2]-th row, the operation is the same as that during the scanning period for the second row from the time t12 to the time T6. Output signals reflecting data for displaying the [L−1]-th row read during the scanning period for the [L−2]-th row from the time T1 to the time T5 are continuously output during the scanning period for the [L−1]-th row at the time T6 to the time T12.

During the period from the time T6 to the time T12, an output signal reflecting the data for displaying the [L−1]-th row is output from the data-side integrated circuit 26. At the same time, an output signal reflecting the data for displaying the L-th row is input to the data-side integrated circuit 26. At the time T7, data of the first column on the L-th row is input to the data-side integrated circuit 26. Then, sequentially in synchronization with each rising of data signals, data of the second column onward on the L-th row is input to the data-side integrated circuit 26. At the time T8 (omitted in FIG. 21), data of the 237-th column on the L-th row is input to the data-side integrated circuit 26. That is, from the time T7 to the time T8, the data for displaying the L-th row in the moving image display area 34 is input to the data-side integrated circuit 26. At the time T9, the time T10, and the time T11, the data of the 238-th column, 239-th column, and the 240-th column, respectively, are input to the data-side integrated circuit 26. With the data input at the time T10, data regarding the lighting of the second pictogram 22 is defined. In the example shown in FIG. 21, data of the 239-th column input at the time T10 is “1111”, although this is not meant to be particularly restrictive.

An output signal reflecting the data for displaying the L-th row read from the time T7 to the time T11 is continuously output during a scanning period for the L-th row from the time T12 to the time T18. During the period from the time T12 to the time T₁₈, the 237 TFTs in the moving image display area 34 and the second pictogram TFT 52 connected to the scan line 7 on the L-th row are in the ON state. Therefore, an output signal reflecting the data read at the time T11 during the scanning period for the [L−1]-th row is supplied to the second pictogram electrode 24, thereby controlling the lighting of the second pictogram 22.

After the scanning period for the L-th row, the operation is the same as that during the scanning period for the second row from the time t12 to the time T6 is applied. Therefore, the data of the 239-th column read after the scanning period for the L-th row may be taken as being undefined.

As the dividing line 103 in the modes of the present invention, a Cr metal is used. Alternatively, another metal or an organic film for use in a color filer or the like can be used.

In the foregoing, description has been made to the nine modes by using pulse-height-modulating (PHM) means performing gray-scale representation with a difference in potential. In any of the examples, pulse-width-modulating (PWM) means performing gray-scale representation with a pulse width can be used. Also, in the nine modes, examples of chip-on-glass implementation have been described. Also, a structure implemented by another scheme, such as TAB implementation, can be similarly used. Furthermore, in the modes described above, normally-white liquid crystal display devices have been described. Also, the present invention can be applied to normally-black devices. As a matter of course, the number of pictograms is not restricted to two, and lighting pictograms are not meant to be restrictive.

In each of the modes described above, a data-side integrated circuit and a scan-side integrated circuit are provided. Alternatively, an integrated circuit including these functions on one chip may be used. Also, the fourth to ninth modes can be combined as appropriated.

As has been evident from the above description, according to the present invention, in a TFT liquid crystal display device that displays a pictogram based on a difference in potential between a common power and a data output signal of a data-side integrated circuit, the data-side integrated circuit is driven according to the polarity of the common power. With this, no segment driver for pictogram display is required, thereby achieving space saving and low cost. Also, in the second mode, the gray scale of the data output signal is adjusted, thereby reducing a direct-current component in pictogram driving. Furthermore, in the third mode, the boundary between the moving image display area and the pictogram display area is made clear, thereby making it easy to view the moving images and also having a less influence on the design of the moving image display area. In the fourth to ninth modes, unlike the second and third modes, no control for suppressing the occurrence of a direct-current component is required. With this, no circuit for this control is required, and therefore space saving can be expected. Still further, according to the modes, a driving power can be reduced.

Particularly, in the fourth to ninth modes, according to the fourth mode, wiring for pictograms is easy, thereby achieving a reduction in a wiring space. Also, according to the fifth mode, wiring for pictograms spaced apart from each other is easy, thereby achieving a reduction in a wiring space. Furthermore, according to the sixth mode, a total impedance of the thin-film transistors driving the pictogram electrodes is reduced. Therefore, it is possible to perform lighting a pictogram having a large area on and off at high speed. Also, the contrast of such a pictogram having a large area can be increased. Furthermore, even if one of a plurality of thin-film transistors connected to one pictogram electrode is normal, the pictogram can be driven. Therefore, a lighting defect ratio of the pictogram can be reduced. Still further, according to the seventh mode, writing to pixels of the pictogram is performed at different timings. Therefore, even if a liquid crystal with a quick response time is used, the contrast is improved. Thus, an alternate-current driving period can be shortened, thereby preventing a deterioration in the liquid crystal. Still further, according to the eighth mode, the thin-film transistor that drives a pictogram electrode is scanned independently from the thin-film transistors in the moving image display area. Therefore, it is possible to preventing the waveform from becoming dull due to a gate capacitance, compared with the case where the thin-film transistor that drives the pictogram electrode is driven together with the thin-film transistors in the moving image display area. Still further, in the ninth mode, even if the number of output terminals of the data-side integrated circuit is small, a plurality of pictograms can be displayed.

### INDUSTRIAL APPLICABILITY

As described above, the present invention is suitable for a liquid crystal display device using TFTs, the liquid crystal display device including two display areas, an area for displaying an unfixed image and an area for displaying a still fixed image, and capable of driving both of the unfixed image and the still fixed image by using a single, space-saving, and low-cost driving driver.

1. A liquid crystal display device capable of displaying a moving image display area for displaying moving images and a pictogram display area, wherein the moving image display area is formed by arranging display electrodes in a matrix, the display electrode being driven by thin-film transistor elements, and the pictogram display area is formed by disposing a segment electrode in a shape of a predetermined pictogram, wherein
a common electrode is provided on an entire position that is opposed to both the moving image display area and the pictogram display area,
a scan-side integrated circuit for driving scan lines is provided so as to be connected to the scan lines connected to the thin-film transistors arranged in a row direction in the moving image display area,
a data-side integrated circuit for driving data lines is provided so as to be connected to the data lines connected to the thin-film transistors arranged in a column direction in the moving image display area, and the data-side integrated circuit is provided with a larger number of output terminals than the data lines, and
the segment electrode is connected to an output terminal, which is different from an output terminal to which data line for moving images is connected, of the data-side integrated circuit, and a difference between a potential of the common electrode and a potential of an output signal from the data-side integrated circuit, which is generated due to driving based on polarity of the common electrode, is used to display the pictogram in the pictogram display.

2. The liquid crystal display device according to claim 1, wherein
an output signal from the data-side integrated circuit to the segment electrode is generated so that an output potential is varied for each predetermined period.

3. The liquid crystal display device according to claim 2, wherein
the output potential varied for each predetermined period is made within a voltage range of the potential of the common electrode, thereby suppressing a direct-current component caused by a difference between the potential of the data output signal and the potential of the common electrode.

4. The liquid crystal display device according to claim 2, wherein
the predetermined period is a period required for inverting a polarity of the common electrode.

5. The liquid crystal display device according to claim 3, wherein
the output potential varied for each predetermined period is controlled by an input signal defining a gray tone to the data-side integrated circuit.

6. A liquid crystal display device capable of displaying a moving image display area for displaying moving images and a pictogram display area, wherein the moving image display area is formed by arranging display electrodes in a matrix, the display electrodes being driven by moving-image thin-film transistor elements, and the pictogram display area is formed by disposing a pictogram electrode in a shape of a predetermined pictogram, the pictogram electrode being driven by a pictogram thin-film transistor element, wherein
a common electrode is provided on an entire position that is opposed to the moving image display area and the pictogram display area,
a scan-side integrated circuit for driving scan lines is provided so as to be connected to the scan lines connected to the moving-image thin-film transistors arranged in a row direction in the moving image display area,
a data-side integrated circuit for driving data lines is provided so as to be connected to the data lines connected to the moving-image thin-film transistors arranged in a column direction in the moving image display area, and to the data-side integrated circuit output terminals are provided in a number that is greater than the number of data lines, and
either one of a source terminal or a drain terminal of the pictogram thin-film transistor is connected to, among a plurality of output terminals of the data-side integrated circuit, an output terminal that is different from output terminals to which the data lines connected to the moving-image thin-film transistors are connected, and other terminal of the pictogram thin-film transistor is connected to the pictogram electrode, a gate terminal of the pictogram thin-film transistor is connected to an output terminal of the scan-side integrated circuit, and a difference between a potential of the common electrode and a potential of the drain terminal of the pictogram thin-film transistor is used to display the pictogram in the pictogram display area.

7. The liquid crystal display device according to claim 6, wherein
the pictogram display area is provided with a plurality of the pictogram electrodes and a plurality of the pictogram thin-film transistors, and gate terminals of the pictogram thin-film transistors are connected to a same output terminal of the scan-side integrated circuit.

8. The liquid crystal display device according to claim 6, wherein
the pictogram display area is provided with a plurality of the pictogram electrodes and a plurality of the pictogram thin-film transistors, and gate terminals of the plurality of pictogram thin-film transistors are connected to different output terminals of the scan-side integrated circuit.

9. The liquid crystal display device according to claim 6, wherein
one pictogram electrode has connected thereto a plurality of the pictogram thin-film transistors.

10. The liquid crystal display device according to claim 9, wherein
gate terminals of a plurality of the pictogram thin-film transistors connected to a same pictogram electrode are connected to different output terminals of the scan-side integrated circuit.

11. The liquid crystal display device according to claim 6, wherein
a gate terminal of the pictogram thin-film transistor is connected to, among a plurality of output terminals of the scan-side integrated circuit, an output terminal that is different from output terminals to which scan lines connected to the moving image thin-film transistor are connected.

12. The liquid crystal display device according to claim 6, wherein
the pictogram display area is provided with the plurality of the pictogram electrodes and the plurality of the pictogram thin-film transistors, and any one of source terminals and drain terminals, which are connected to the pictogram electrodes, of the plurality of the pictogram thin-film transistors, are connected to a same output terminal of the data-side integrated circuit, and other terminals of the plurality of pictogram thin-film transistors are connected to different output terminals of the scan-side integrated circuit.
